(19) United States
(12) Patent Application Publication
(10) Pub. No.: US 2012/0270992 A1
(43) Pub. Date: Oct. 25, 2012

(54) SURFACTANT-FREE CORE-SHELL HYBRID LATEXES

(76) Inventors: Richard C. Larock, Palm Springs, CA (US); Yongshang Lu, Woodbury, MN (US)

(21) Appl. No.: 13/452,171

(22) Filed: Apr. 20, 2012

Related U.S. Application Data
(60) Provisional application No. 61/478,315, filed on Apr. 22, 2011.

(51) Int. Cl. C08L 13/02; C09J 113/02; C09D 113/02; B82Y 40/00; B82Y 99/00

(52) U.S. Cl. 524/507; 977/773; 977/788; 977/902; 977/897

(57) ABSTRACT

The invention provides core-shell hybrid latexes wherein the core comprises poly(acrylate)polymers and the shell comprises vegetable oil-based waterborne polyurethanes, and the latexes lack surfactants. Surfactant-free core-shell hybrid latexes with waterborne vegetable oil-based polyurethanes as the shell and poly(acrylate) as the core have been successfully prepared by seeded emulsion polymerization. The crosslink densities of the polymers obtained can be controlled by using modified vegetable oil polyols with various hydroxyl numbers or by adding a multifunctional vinyl crosslinker to the poly(acrylate) core.

### RELATED APPLICATIONS

This application claims priority under 35 U.S.C. §119(e) to U.S. Provisional Patent Application No. 61/478,315, filed Apr. 22, 2011, which is incorporated herein by reference.

### BACKGROUND OF THE INVENTION

Waterborne liquid polymer emulsions that utilize water as the major carrier are an important class of materials, especially in the paint and coating industries. A large portion of the waterborne paint produced worldwide is sold into the architectural market. For example, over 70% of architectural paints used in the United States are classified as waterborne. Coatings applied to cans and automobiles (e.g. basecoat) represent the next largest market for waterborne coatings. The advantages exhibited by waterborne formulations include low viscosities, very little volatile organic compounds (VOCs), reduced flammability, reduced odor, and easy application using conventional equipment.

Waterborne polyurethane (PU) dispersions and acrylic latexes have been widely applied as binders for paints and coatings. However, both systems have some disadvantages, including the reduced film formation, lower chemical resistance, and coarse mechanical properties of acrylics, and the high cost, low pH stability, and limited outdoor durability of PUs. In order to combine the advantages of acrylic polymers, which include hardness, gloss, weatherability and chemical resistance, with the advantages of PUs, which include excellent adhesion and toughness, acrylic monomers have been polymerized in the presence of a PU dispersion using various techniques, including core-shell polymerization, seeded polymerization and the formation of interpenetrating networks to obtain hybrid emulsions. These PU/acrylic hybrid latexes have been used as coatings, adhesives, sealants for buildings, as well as coatings for fabrics and leather.

While improvements have been made toward providing useful PU/acrylic hybrid latexes, there still exists a need for hybrid latexes that, for example, can be prepared from inexpensive and environmentally friendly materials. There is also a need for hybrid latexes that can be prepared safely and economically, and that provide further improved properties.

### SUMMARY

It was surprisingly discovered that core-shell hybrid latexes of vegetable oil-based waterborne polyurethanes and poly(acrylates) can be prepared in the absence of surfactants. The invention therefore provides core-shell hybrid latexes where the core includes poly(acrylate)polymers and the shell comprises vegetable oil-based waterborne polyurethanes, where the latexes lack surfactants, and surfactants are not needed for their preparation. The vegetable oil-based polyurethane can be covalently crosslinked to the poly(acrylate)polymer, and the particle can have a diameter of about 30 nm to about 150 nm.

In one embodiment, the shell comprises a soybean oil-based polyurethane and the core comprises a poly(styrene-acrylate)polymer, and the soybean oil-based polyurethane is crosslinked to the poly(styrene-acrylate)polymer.

The invention also provides a latex emulsion that includes a plurality of core-shell particles described herein and an aqueous solvent system. The latex emulsion can be substantially or completely free of surfactants. The latex emulsion can be used to provide a latex film comprising a dried layer of a plurality of the core-shell particles described herein. The film can have greater thermal stability than a corresponding film that lacks a poly(acrylate)polymer component, for example, as determined by thermal gravimetric analysis. Additionally, the tensile strength of the file can be greater than twice the tensile strength of a corresponding film that lacks a poly(acrylate)polymer component.

The invention also provides methods to prepare a core-shell hybrid latex. The methods can include contacting a vegetable-oil based waterborne polyurethane dispersion, one or more acrylates, an effective polymerization initiator, and water, in the absence of a surfactant; optionally in the presence of a divinyl crosslinker; under suitable reaction conditions, thereby effecting the polymerization of the vegetable-oil based waterborne polyurethane, the acrylates, and optionally the divinyl crosslinker, to form a core-shell hybrid latex. The resulting core-shell hybrid latex can be dried to provide a film, or the latex can be used as a component of a coating, paint, adhesive, or ink formulation.

Accordingly, the invention provides novel polymer compounds and compositions, intermediates for the synthesis of such polymer compounds and compositions, as well as methods of preparing and using the compounds and compositions. The invention also provides polymer compounds that are useful as intermediates for the synthesis of other useful compounds and compositions.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Conversion of vinyl monomers as a function of polymerization time.

FIG. 2. TEM images of an SPU135 dispersion (a) and the core-shell latex SPU135-40 with MMA in the core [(b), low magnification, and (c), high magnification].

FIG. 3. DSC thermograms of SPU135 with varying amounts of poly(ST-BA) as the core.

FIG. 4. DSC thermograms of SPU149-30, SPU176-30, and SPU135-30 with varying amounts of diethylene glycol dimethyl methacrylate (DGDM) as the crosslinker.

FIG. 5. TGA curves for SPU135 with varying amounts of poly(ST-BA) as the core. At 50% weight loss, from left to right: SPU135, SPU135-20, SPU135-30, SPU135-40, SPU135-50, SPU135-60.

FIG. 6. TGA curves for SPU135-30, SPU176-30 and SPU135-27-3 (left to right at 30% weight loss, respectively).

FIG. 7. Stress-strain curves of SPU135 and its core-shell latexes with different poly(ST-BA) content.

FIG. 8. Stress-strain curves of the core-shell latexes from SPU135-30 with varying amounts of crosslinking reagent.

FIG. 9. Stress-strain curves of the core-shell latexes from SPU135, SPU149 and SPU176 with 30 wt % poly(ST-BA).

### DETAILED DESCRIPTION

The invention provides surfactant-free core-shell hybrid latexes from vegetable oil-based waterborne polyurethanes and poly(styrene-butyl acrylate). For example, novel surfactant-free core-shell hybrid latexes have been successfully synthesized by seeded emulsion polymerization of 10-60 wt. % vinyl monomers (styrene and butyl acrylate) in the presence of a soybean oil-based waterborne polyurethane (PU) dispersion as seed particles. The vegetable oil-based waterborne polyurethanes can be synthesized, for example, by reacting isophorone diisocyanate (IPDI) with methoxylated soybean oil polyols (MSOL) and dimethylol propionic acid (DMPA), to form the latex shell, which can serve as a polymeric high molecular weight emulsifier, while the vinyl polymers form the core.

The structures and thermal and mechanical properties of the PU dispersions and the resulting core-shell latexes have been characterized by transmission electron microscopy (TEM), differential scanning calorimetry (DSC), thermal gravimetric analysis (TGA) and measurement of the mechanical properties. The core-shell hybrid latex films show a significant increase in thermal stability and mechanical properties when compared with the corresponding pure polyurethane films, and they exhibit a change in mechanical behavior from elastomeric polymers to tough and hard plastics, due to grafting and crosslinking in the hybrid latexes.

### Preparation of the Core-Shell Hybrid Latexes

Conventional emulsion copolymerization is a process in which a copolymer is formed directly in water using surfactants (i.e., compounds that are able to form micelles in the aqueous phase), which stabilize the copolymer particles in the emulsion. The surfactants used in conventional emulsion copolymerization may be non-ionic (e.g., alkyl or alkylphenol ethoxylated derivatives); anionic (e.g., salts of alkyl sulfates, phosphates or sulfonates); or cationic (e.g., quaternary ammonium salts of alkyl amines). Using such surfactants, which remain in the free form as a water soluble species in the emulsion, can cause problems when the emulsions are used as coating compositions, such as poor humidity and corrosion performance, because of the presence of free surfactants that remain in the final film. It would therefore be an advantage if such copolymer emulsions could be prepared without the use of the monomeric, water sensitive surfactants.

The functionalized waterborne polyurethanes can be prepared by combining a vegetable oil derived polyol, a diisocyanate, and a di- or poly-hydroxy acid under suitable conditions, in a suitable and effective organic solvent. The reaction can be facilitated by heating the mixture in the solvent, for example, at about 50° C. to about 100° C. The urethane moieties of the polyurethanes can be derived from a hydroxyl moiety of a vegetable oil derived polyol and an isocyanate moiety of a diisocyanate, and from a hydroxy moiety of a di- or poly-hydroxy acid and an isocyanate moiety of a diisocyanate, to form the polyurethanes.

A variety of vegetable oil polyols can be used to prepare the polyurethanes. Suitable polyurethanes can be prepared from methoxylated vegetable oils, ethoxylated vegetable oils, acrylated vegetable oils, and polyols prepared by epoxidizing a vegetable oil polyol followed by epoxide ring opening with an acid, such as HCl. Methoxylated vegetable oils and ethoxylated vegetable oils can also include epoxides and/or unsaturated bonds (e.g., double bonds) in the fatty acid chains of their triglyceride groups. Epoxidized vegetable oils and vegetable oil-based polyols can be prepared by the methods described by Lu and Larock (Biomacromolecules 2007, 8, 3108-3114), and acrylated epoxidized vegetable oils can be prepared as described by Lu and Larock (J. Appl. Polym. Sci., Vol. 119, 3305-3314 (2011). Techniques for modifying vegetable oils to provide vegetable oil polyols are also described by U.S. Pat. No. 7,786,239 (Petrovic et al.), incorporated herein by reference.

Any suitable and effective diisocyanate or triisocyanate can be used in preparation of the vegetable oil-based polyurethanes. Examples suitable and effective diisocyanates include toluene diisocyanate, tetramethylene diisocyanate, hexamethylene diisocyanate, isophorone diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate, 1,3-phenylene diisocyanate, 4,4′-biphenylene diisocyanate, 1,5-naphthalene diisocyanate, bis-(4-isocyanatocyclohexyl)-methane, 4,4′-diisocyanatodiphenyl ether, tetramethyl xylene diisocyanate, and the like.

A variety of dihydroxy acids can be used in preparation of the vegetable oil-based polyurethanes. Suitable and effective examples include dihydroxypropionic acid, dimethylol propionic acid, dihydroxysuccinic acid and dihydroxybenzoic acid. Other suitable compounds are the polyhydroxy acids, which can be prepared by, for example, oxidizing monosaccharides such as gluconic acid, saccharic acid, mucic acid, glucuronic acid, and the like.

One specific preparation of functionalized waterborne polyurethanes is described below in Examples 1 and 2. The surfactant-free preparation of core-shell hybrid latexes is described below in Example 3. Any suitable acrylate polymer can be used to prepare the poly(acrylate)polymer core in place of the poly(styrene-acrylate)polymer described in Example 3.

Accordingly, the functionalized waterborne PUs can contain various amounts of a bio-based monomer, such as acrylated epoxidized soybean oil or methoxylated soybean oil. The functionalized PUs are readily copolymerized with other acrylic monomers to prepare the core-shell hybrid latexes in the absence of surfactants, resulting in good thermal stability and mechanical properties. As a result, both the starting materials and final products are more environmentally friendly and economically sustainable than petroleum-based hybrid latexes. Surfactant-free core-shell hybrid latexes with waterborne soybean oil-based polyurethanes as the shell and poly(styrene-acrylate) (10-60 wt. %) as the core have been successfully prepared by seeded emulsion polymerization. In one embodiment, the poly(styrene-acrylate) can be poly(styrene-butyl acrylate) [poly(ST-BA)]. However, any suitable and effective acrylate polymer or copolymer can be used. For example, substituted styrene monomers can be used, and other acrylates, such as any (C₁-C₂₀)alkyl acrylate or methacrylate can replace the butyl acrylate.

In various embodiments, the vinyl monomer used for synthesis of core-shell latex can include those obtained by interpolymerizing one or more ethylenically unsaturated monomers containing carboxylic acid groups with other ethylenically unsaturated monomers including, for example, alkyl esters of acrylic or methacrylic acid. Specific examples include methyl methacrylate, ethyl methacrylate, butyl methacrylate, ethyl acrylate, butyl acrylate, hexyl acrylate, n-octyl acrylate, lauryl methacrylate, 2-ethylhexyl methacrylate, nonyl acrylate, or benzyl methacrylate; the hydroxyalkyl esters of the aforementioned acrylates, such as 2-hydroxyethyl acrylate, 2-hydroxyethyl methacrylate, and 2-hydroxypropyl methacrylate; nitriles and amides of the aforementioned acrylates, such as acrylonitrile, methacrylonitrile, and methacrylamide; vinyl acetate; vinyl propionate; vinylidene chloride; vinyl chloride; and vinyl aromatic compounds such as styrene, t-butyl styrene and vinyl toluene; dialkyl maleates; dialkyl itaconates; dialkyl methylene-malonates; isoprene; and butadiene. Suitable ethylenically unsaturated monomers containing carboxylic acid groups include acrylic monomers such as acrylic acid, methacrylic acid, ethacrylic acid, itaconic acid, maleic acid, and fumaric acid; monoalkyl itaconates including monomethyl itaconate, monoethyl itaconate, and monobutyl itaconate; monoalkyl maleates including monomethyl maleate, monoethyl maleate, and monobutyl maleate; citraconic acid; and styrenecarboxylic acid.

The crosslink densities of the polymers obtained have been controlled by using methoxylated soybean oil polyols with varying hydroxyl numbers or by adding a multifunctional vinyl crosslinker to the poly(ST-BA) core. Numerous suitable divinyl crosslinkers are described below. Chain transfer agents or mixtures thereof known in the art, such as alkyl-mercaptans, can be used to control the polymer molecular weight.

The structures and thermal and mechanical properties of the core-shell latexes and the resulting films have been thoroughly characterized. TEM images clearly show the formation of a core-shell structure in the hybrid latexes. The T_{g}s of the films obtained increase with incorporation of the poly(ST-BA), along with an increase in the crosslink densities, in both the shell and core. Moreover, the core-shell hybrid latex films show a significant increase in their thermal stabilities, because of the incorporation of the more thermally stable poly(ST-BA). Compared to the pure polyurethane films, the hybrid latex films' mechanical properties, namely their Young's moduli and tensile strengths, are enhanced significantly and they are further enhanced by an increase in the crosslink density of both the SPU shell and the poly(ST-BA) core. The properties of the latex films obtained from the latexes range from elastomeric polymers to tough and hard plastics, due to grafting and crosslinking in the hybrid latexes, indicating that these coatings are promising environmentally-friendly bioplastics with many valuable applications.

The invention therefore provides methods for preparing a core-shell hybrid latex. In certain specific embodiments, the methods can include contacting a soybean-oil based waterborne polyurethane dispersion, styrene, an acrylate, an effective polymerization initiator, and water; at a temperature of about 30° C. to about 100° C.; for example, at about 70-90° C., or about 80° C. The contacting can optionally be carried out in the presence of a divinyl crosslinker, such as DGDM, divinyl benzene, or another divinyl crosslinker recited herein. This reaction mixture results in the polymerization of the soybean-oil based waterborne polyurethane, the styrene, the acrylate, and optionally the divinyl crosslinker, to form a core-shell hybrid latex that lacks surfactants. Styrene and acrylate monomers, such as ST-BA monomers, are thus copolymerized with the residual double bonds in the soybean oil fatty acid chains to reinforce interactions between the PU shell and the poly(ST-BA) core.

In various embodiments, the styrene and the acrylate can be present in a ratio of about 40:60 to about 90:10 by weight, respectively. The weight ratio of the polyurethane and the sum of the styrene and the acrylate can be about 90:10 to about 10:90, or about 90:10 to about 40:60. In various embodiments, about 0.5 wt. % to about 5 wt. % of a divinyl crosslinker can be present in the reaction mixture.

The vegetable oil-based waterborne polyurethane can be prepared from methoxylated vegetable oil polyols, such as methoxylated soybean oil polyols. For example, the soybean oil-based waterborne polyurethane can be prepared from methoxylated soybean oil polyols, isophorone diisocyanate (IPDI), and dimethylol propionic acid (DMPA).

The resulting core-shell hybrid latex can be used, for example, as a binder component in a coating, paint, or adhesive formulation, or the core-shell hybrid latex can be dried to provide a film. The film can include a variety of poly(acrylate) or poly(styrene-acrylate) content, such as about 10 wt. %, about 20 wt. %, about 30 wt. %, about 40 wt. %, about 50 wt. %, about 60 wt. %, about 70 wt. %, about 80 wt. %, or about 90 wt. %.

The invention therefore provides various embodiments of core-shell hybrid latex particles and their corresponding latex emulsions. The invention thus provides a core-shell hybrid latex particle wherein the shell comprises a vegetable oil-based polyurethane and the core comprises a poly(acrylate)polymer, and the vegetable oil-based polyurethane is crosslinked to the poly(acrylate)polymer. The particle can have a diameter of, for example, about 30 nm to about 150 nm.

The vegetable oil of the vegetable oil-based polyurethane can be derived from, for example, almond oil, canola oil, castor oil, coconut oil, corn oil, cottonseed oil, flax seed oil, grape seed oil, hazelnut oil, linseed oil, olive oil, palm oil, palm kernel oil, peanut oil, rapeseed oil, rice bran oil, safflower oil, sesame oil, soybean oil, sunflower seed oil, or a combination thereof. In one particular embodiment, the vegetable oil of the vegetable oil-based polyurethane is derived from soybean oil.

The vegetable oil of the vegetable oil-based polyurethane can be derived from ethoxylated vegetable oil polyols, epoxidized vegetable oil polyols, methoxylated vegetable oil polyols, or a combination thereof. In some embodiments, the poly(acrylate)polymer can be a poly(styrene-acrylate)polymer. For example, the shell can include a soybean oil-based polyurethane and the core can include a poly(styrene-acrylate)polymer, and the soybean oil-based polyurethane can be crosslinked to the poly(styrene-acrylate)polymer. The particle can include less than 1 wt. % surfactants, less than 0.1 wt. % surfactants, or the particle can be free or essentially free of surfactants.

The acrylate component of the poly(acrylate)polymer can include (C₁-C₂₀)alkyl acrylate monomers, substituted (C₁-C₂₀)alkyl acrylate monomers, (C₁-C₂₀)alkyl methacrylate monomers, substituted (C₁-C₂₀)alkyl methacrylate monomers, or a combination thereof. In one specific embodiment, the acrylate component includes butyl acrylate monomers.

The particle can include about 10 wt. % to about 95 wt. % of the poly(acrylate) or the poly(styrene-acrylate)polymer moiety. In other embodiments, the particle can include about 10 wt. % to about 60 wt. %; or about 30 wt. % of the poly(acrylate) or the poly(styrene-acrylate)polymer moiety. In yet other embodiments, the hybrid latexes can utilize as high as 66 weight % of a vegetable oil-based polyol to provide properties superior to corresponding particles that lack a poly(acrylate)polymer component. The poly(styrene-acrylate)polymer can include about 34 wt. % to about 90 wt. % styrene moieties, about 40 wt. % to about 90 wt. % styrene moieties, or about 50 wt. % to about 75 wt. % styrene moieties.

The vegetable oil-based polyurethane can include methoxylated vegetable oil moieties, ethoxylated vegetable oil moieties, epoxidized vegetable oil moieties, ring opened epoxidized vegetable oil moieties, or a combination thereof The methoxylated vegetable oil moieties can have, for example, about 2.4 to about 4 hydroxy or methoxy substituents per triglyceride moiety. In other embodiments, the methoxylated vegetable oil moieties can have about 2.3 to about 4 hydroxy or methoxy substituents, about 2.4 to about 4 hydroxy or methoxy substituents, or at least about 3 to about 4 hydroxy or methoxy substituents per triglyceride moiety. The vegetable oil can be, for example, soybean oil, or another vegetable oil recited herein.

The vegetable oil-based polyurethane can include polymerized diisocyanate moieties that link the vegetable oil polyol and di- or poly-hydroxy acids to form a polyurethane. The polymerized diisocyanate moieties can be, for example, polymerized moieties of isophorone diisocyanate (IPDI), toluene diisocyanate, tetramethylene diisocyanate, hexamethylene diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate, 1,3-phenylene diisocyanate, 4,4′-biphenylene diisocyanate, 1,5-naphthalene diisocyanate, bis-(4-isocyanatocyclohexyl)-methane, 4,4′diisocyanatodiphenyl ether, tetramethyl xylene diisocyanate, or a combination thereof.

The vegetable oil-based polyurethane can include polymerized di- or poly-hydroxy acids. In one embodiment, the dihydroxy acid is dimethylol propionic acid (DMPA). In one embodiment, the polyurethane of the latex shell, serving as a polymeric high molecular weight emulsifier, comprises the polymerization product of methoxylated soybean oil polyols, isophorone diisocyanate (IPDI), and dimethylol propionic acid (DMPA).

In one embodiment, the shell includes a polymer of Formula I:

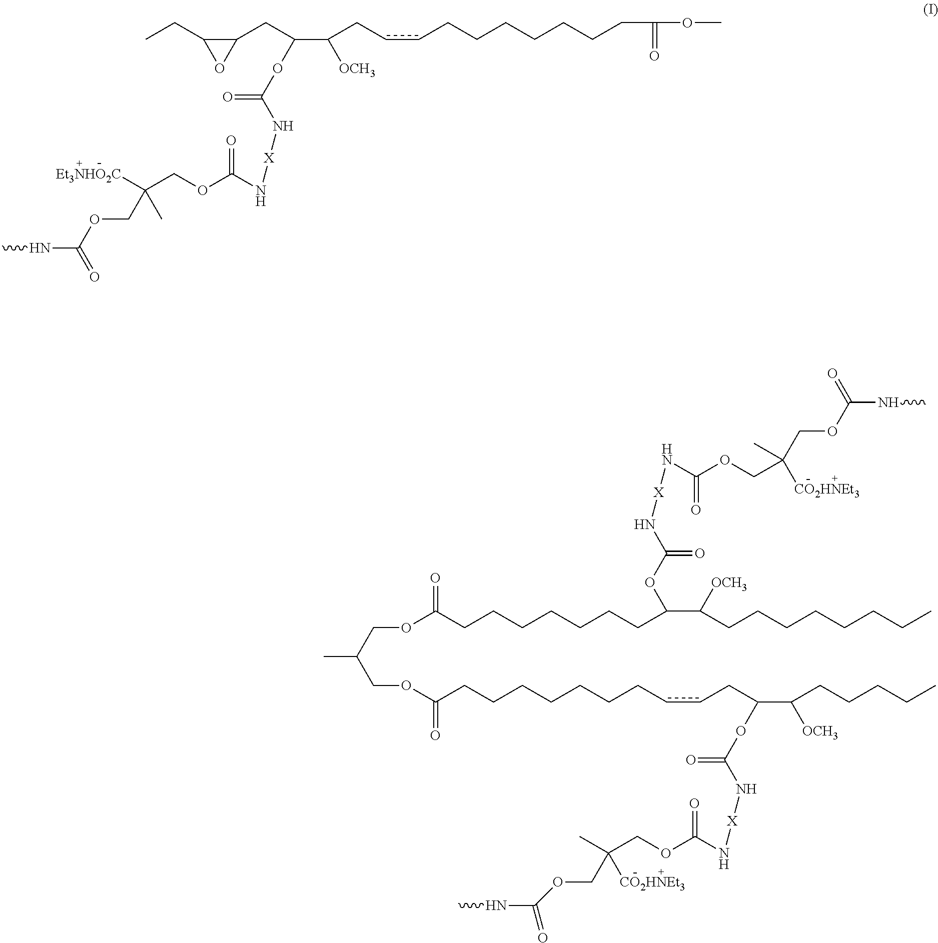

wherein each X is independently a divalent alkyl, cycloalkyl, or aryl; and the dashed bonds are double bonds or cites at which the polymer of Formula I is covalently bonded to the poly(acrylate)polymer of the core. Thus, in some embodiments, the polymer of Formula I is covalently bonded to the poly(acrylate)polymer of the core at one or more of the optional olefinic moieties designated by dashed bonds, provided that at least one olefinic moiety is present in a Formula I in the particle.

In another embodiment, the shell comprises a polymer of Formula II:

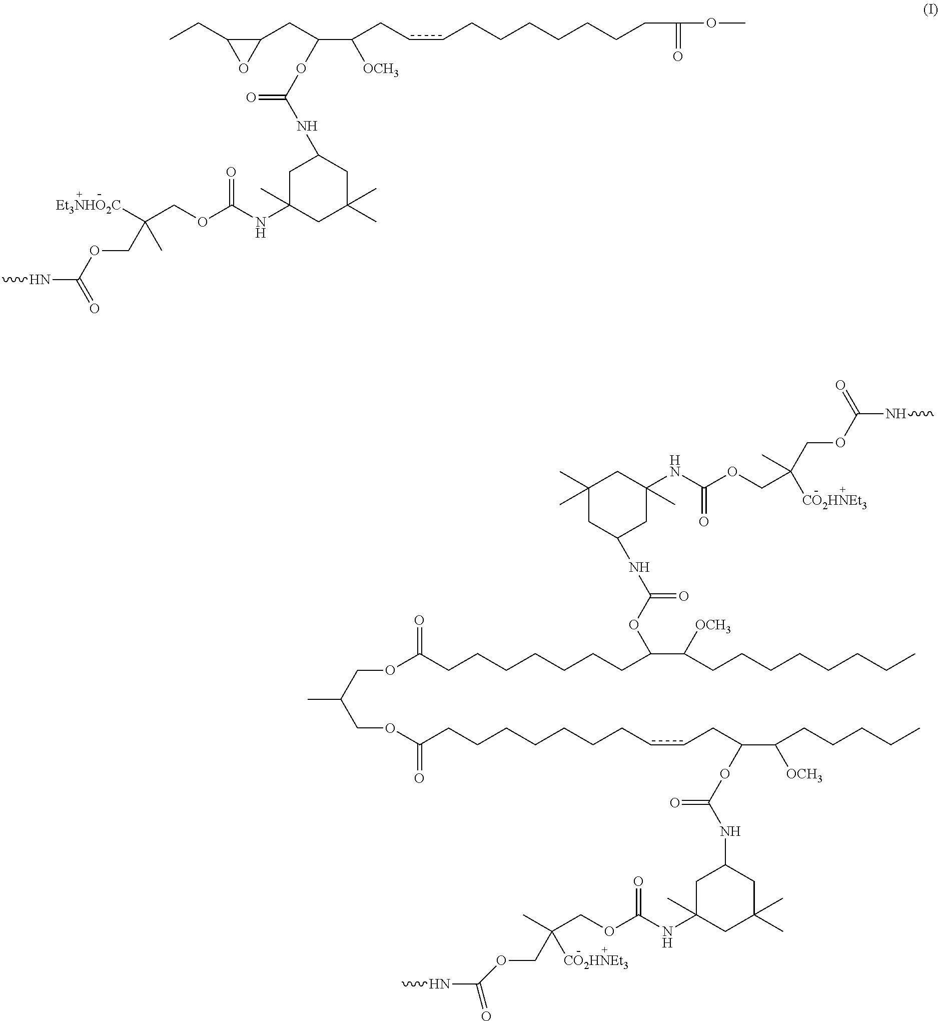

wherein the polymer of Formula II is covalently bonded to the poly(acrylate)polymer of the core at one or more of the optional olefinic moieties designated by dashed bonds, provided that at least one olefinic moiety is present in a Formula II of the particle.

In some embodiments, the vegetable oil-based polyurethane and the poly(acrylate)polymer are crosslinked through divinyl moieties. The divinyl moiety can be derived from, for example, diethylene glycol dimethyl methacrylate (DGDM), divinyl benzene, or another divinyl crosslinker recited herein. In some embodiments, the vegetable oil-based polyurethane is directly crosslinked to a poly(styrene-acrylate)polymer. There can also be combinations of direct crosslinking and crosslinking through divinyl derived groups.

The invention also provides a latex emulsion that includes a plurality of core-shell particles as described herein and an aqueous solvent system. The latex emulsion can be free of surfactants or substantially free of surfactants. For example, the composition can include less than 1 wt. % of surfactants, or less than 0.1 wt. % of surfactants.

The invention further provides a latex film comprising a dried layer of a plurality of core-shell particles as described herein. The film can possess a soft segment glass transition temperature and a hard segment glass transition temperature. In some embodiments, the film has greater thermal stability than a corresponding film that lacks a poly(acrylate) or a poly(styrene-acrylate)polymer component, for example, as determined by thermal gravimetric analysis. The T₅ value of the film can be greater than 245° C., as determined by thermal gravimetric analysis. In some embodiments, the T₅ value of the film can be up to about 285° C. The T₅₀ value of the film can be greater than 375° C., as determined by thermal gravimetric analysis. In some embodiments, the T₅ value of the film can be up to about 425° C.

In various embodiments, the tensile strength of the film can be greater than about 5 MPa. In other embodiments, the tensile strength can be greater than about 10 MPa. In some embodiments, the tensile strength is greater than twice the tensile strength of a corresponding film that lacks a poly(acrylate) or a poly(styrene-acrylate)polymer component.

In some embodiments, the Young's modulus of the film is greater than about 20 MPa. In other embodiments, Young's modulus is greater than about 200 MPa. In further embodiments, the Young's modulus is more than 30 times the Young's modulus of a corresponding film that lacks a poly(acrylate) or a poly(styrene-acrylate)polymer component.

The invention further provides methods to prepare a core-shell hybrid latex. The method can include contacting a vegetable-oil based waterborne polyurethane dispersion, one or more acrylates, an effective polymerization initiator, and water; under suitable reaction conditions to effect the polymerization of the vegetable-oil based waterborne polyurethane, the acrylates, and optionally the divinyl crosslinker, to form a core-shell hybrid latex, in the absence of a surfactant. The contacting can also include the presence of a divinyl crosslinker. Suitable reaction conditions can include an organic solvent and a temperature of about 30° C. to about 100° C., for example, about 50° C., about 60° C., about 70° C., or about 80° C.

The styrene and the acrylate can be present in a ratio of about 40:60 to about 90:10 by weight. The weight ratio of the polyurethane and the sum of the acrylate and the (optionally present) styrene can be about 90:10 to about 40:60. In some embodiments, about 0.5 wt. % to about 5 wt. % of a divinyl crosslinker is present.

In one embodiment, the vegetable oil-based waterborne polyurethane can be prepared from methoxylated vegetable oil polyols. In another embodiment, the vegetable oil-based waterborne polyurethane can be prepared from methoxylated soybean oil polyols. In some embodiments, the soybean oil-based waterborne polyurethane can be prepared from, for example, methoxylated soybean oil polyols, isophorone diisocyanate (IPDI), and dimethylol propionic acid (DMPA).

The polymerization initiator can be any suitable and effective free radical initiator. Examples include persulfates, peroxides, azo compounds, or redox initiators. Specific examples include persulfates such as ammonium persulfate, potassium persulfate (K₂S₂O₈), and the like; peroxides such as hydrogen peroxide, benzoyl peroxide, cumene hydroperoxide, tertiary butyl peroxide, and the like; azo compounds such as azobiscyanovaleric acid, azoisobutyronitrile, and the like; and redox initiators such as hydrogen peroxide-iron(II) salt, potassium persulfate-sodium hydrogen sulfate, and the like. Chain transfer agents or mixtures thereof known in the art, such as alkyl-mercaptans, can be used to control the polymer molecular weight.

The resulting core-shell hybrid latex can be dried to provide a film. Alternatively, the resulting core-shell hybrid latex can be combined with one or more defoamers, substrate wetting agents, rheology control additives, matting agents, coalescing agents, dispersants, adhesives, and/or water to form a coating, paint, or adhesive formulation.

The invention further provides a composition having low volatile organics content and low odor that is suitable for forming coatings, adhesives, and inks formulations. The composition can include an aqueous emulsion composed of a polymer obtained by the polymerization of (a): (i) a vegetable oil polyol having at least one double bond, (ii) a diisocyanate, and (iii) a di- or poly-hydroxy acid; and (b) one or more ethylenically unsaturated monomers copolymerizable therewith; in the absence of a surfactant, to form a core-shell latex as described herein. The invention further provides a process for the formation of a waterborne core-shell particle for coatings, paints, inks or adhesives containing a plurality of the core-shell particles by polymerizing a vegetable oil-derived polyurethane as described herein with one or more ethylenically unsaturated monomers copolymerizable therewith; in the absence of a surfactant.

### Uses of the Core-Shell Hybrid Latexes

The core-shell hybrid latexes described herein have a variety of uses and advantages over known latexes prepared with surfactants. By adding the hybrid latexes to a composition, the use of petroleum feedstocks can be minimized in the preparation of decorative and protective coatings and adhesive production. Their use also allows for the preparation of more environmentally-friendly coatings and adhesives, reduces air pollution by lowering the volatile organic content (VOC) of the coatings, and increases the safety of the end use application process, particularly in the area of decorative coatings and adhesives for use in homes and offices. The use of the hybrid latexes will encourage a shift away from traditional petroleum-based technologies and toward newer bio-based technologies with improved health and safety profiles. For example, in some embodiments the hybrid latexes can utilize as high as 66 weight % of soybean oil-based polyol as one of the abundant annually renewable resources to produce final value-added products with high performance.

Most of the known polyurethanes (PUs) used for the preparation of PU/acrylic hybrid latexes and core-shell latexes are made from petroleum-based chemicals, such as polypropylene glycol, polyethylene glycol, polyester, and the like. The vegetable oil-based waterborne PU/acrylic hybrid latexes described herein can be used as components, for example, in coatings, binders, adhesives, sealants, fibers and foams. Their use allows for value-added applications for decorative and protective coatings, paints, and adhesive materials, such as coatings for furniture components, automotive basecoats, as well as pressure sensitive adhesives.

The latexes described herein can be used as, for example, an aqueous coating composition. The phrase “aqueous coating composition” is intended to encompass compositions containing an aqueous phase (e.g., water) that are applied to substrates. Illustrative coatings that can utilize a composition of the invention include wood coatings, such as, e.g., stains, seal coat/sealers, topcoats, wiping stains, glazes, and fillers. Examples of other coatings include paints (e.g., house paints), primers; clear coatings; semi-gloss coatings; gloss coatings; architectural coatings; industrial coatings; maintenance coatings; general metal-type coatings; paper coatings, including textile treatments; plastics coatings, such as primers, base coats, top coats, and adhesion promoters; and polishes.

The latex compositions thus may be formulated into a wide variety of materials such as adhesives and inks formulations having a diverse variety of applications. In one embodiment, the emulsion polymers can be useful as binders in ink formulations. Ink formulations can differ from coating formulations in terms of the amounts of crosslinking monomers used. For example, ink formulations can generally contain higher amounts of a crosslinker. Additionally, ink formulations may contain higher amounts of driers and drier accelerators for fast drying of these formulations. Accordingly, an ink formulation containing a latex emulsion as described herein may be obtained by adding one or more pigments to the emulsion in accordance with well-known methods in the art. The compositions may also be employed in forming radiation curable formulations, for example, UV curable high gloss coatings, inks, and adhesives formulations.

An adhesive formulation containing a latex emulsion as described herein may similarly be obtained in accordance with well-known methods in the art. For example, an adhesive formulation may be formed using a latex emulsion in combination with one or more surfactants or protective colloids, and one or more of various other additives described herein. The adhesive formulations can be in the form of an emulsion and/or aqueous solution. However, dry-mix, hot-melt, or solutions in organic solvent can also be formed using the latex particle described herein. A detailed description of adhesive formulations can be found in “Handbook of Adhesives,” 2nd Ed., I. Skiest; Chapter 28, pp 465-494 (1977), Van Nostrand Reinhold Co., incorporated herein by reference in its entirety.

The compositions of this invention thus have utility in a diverse variety of applications. For instance, the compositions can be converted to a redispersible latex powder by physical drying of the latex composition. The compositions can also be used to form solvent-free coatings such as adhesives, including pressure sensitive and contact adhesives, which can be used either at ambient or elevated temperatures. The inks or coatings formulations formed from the compositions may be in the form of a waterborne latex or may be in the form of 100% solids. A significant advantage of these compositions is that the coatings, inks, and adhesives formed from these compositions are essentially solvent and VOCs free, thus eliminating environmental pollution while featuring enhanced material properties.

The use of petroleum-based hybrid latexes puts significant pressure on our finite petroleum reserves and raises environmental concerns due to their persistence in the environment. The mechanical properties of the petroleum-based hybrid latexes are comparable to or inferior to those of vegetable oil-based hybrid latex products that can be prepared as described herein. Furthermore, due to the low cost of the starting materials and simple and mild reaction conditions, the final price of such bio-based materials will compare favorably with or beat the price of currently available petroleum-based latexes.

### Definitions

As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation.

The term “and/or” means any one of the items, any combination of the items, or all of the items with which this term is associated. The phrase “one or more” is readily understood by one of skill in the art, particularly when read in context of its usage. For example, one or more substituents on a phenyl ring refers to one to five, or one to four, for example if the phenyl ring is disubstituted, such as a para-hydroxy styrene or para-nitro styrene monomer.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer. Unless indicated otherwise herein, the term “about” is intended to include values, e.g., weight percents, proximate to the recited range that are equivalent in terms of the functionality of the individual ingredient, the composition, or the embodiment.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible sub-groups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

The term “contacting” refers to the act of touching, makirig contact, or of bringing to immediate or close proximity, including at the cellular or molecular level, for example, to bring about a physiological reaction, a chemical reaction, or a physical change, e.g., in a solution, or in a reaction mixture.

An “effective amount” refers to an amount effective to bring about a recited effect. The term “effective amount” is intended to include an amount of a compound, or an amount of a combination of compounds, e.g., that is effective to initiate a reaction or result in a specified product. Thus, an “effective amount” generally means an amount that provides the desired effect.

The phrase “substantially free of surfactants” refers to a composition that is completely free of surfactants or that any surfactants that are present do not interfere with the intended use of the product composition. For examples, in some embodiments, the composition has less then 2 wt. % surfactants, less then 1 wt. % surfactants, less then 0.5 wt. % surfactants, less then 0.1 wt. % surfactants, or no detectable surfactants at all.

The term “vegetable oil” is well known in the art, and refers to the triglycerides of an oil obtained from the seeds of a vegetable. Examples of vegetable oils include, but are not limited to, almond oil, canola oil, castor oil, coconut oil, corn oil, cottonseed oil, flax seed oil, grape seed oil, hazelnut oil, linseed oil, olive oil, palm oil, palm kernel oil, peanut oil, rapeseed oil, rice bran oil, safflower oil, sesame oil, soybean oil, and sunflower seed oil. A “vegetable oil polyol” refers to a vegetable oil that has more than one hydroxyl per molecule, and/or that has been modified, for example, by epoxidation and ring opening to install additional hydroxy groups on the fatty acid chains of the triglycerides. In some embodiments, the molecules of the vegetable oil polyol can include at least one unreacted double bond. Vegetable oil polyols are further described by, for example, U.S. Pat. No. 7,786,239 (Petrovic et al.), which is incorporated herein by reference.

Vegetable oils of the type described herein are typically composed of triglycerides of fatty acids. The fatty acids can be saturated, monounsaturated, or polyunsaturated and include varying carbon chain lengths ranging from C₁₂ to C₂₄. Common fatty acid moieties of the triglycerides include saturated fatty acids such as lauric acid (dodecanoic acid), myristic acid (tetradecanoic acid), palmitic acid (hexadecanoic acid), steric acid (octadecanoic acid), arachidic acid (eicosanoic acid), and lignoceric acid (tetracosanoic acid); unsaturated acids such as palmitoleic (a C16 acid), and oleic acid (a C18 acid); polyunsaturated acids such as linoleic acid (a di-unsaturated C18 acid), linolenic acid (a tri-unsaturated C18 acid), and arachidonic acid (a tetra-unsubstituted C20 acid). The triglyceride oils are esters of these fatty acids in random placement onto the three sites of the trifunctional glycerine molecule.

Different vegetable oils will have different ratios of these fatty acids. Within a given vegetable oil there is a range of these fatty acid moieties. The composition of a particular vegetable oil can depend factors such as where the vegetable or crop was grown, the maturity of the vegetable or crop, the weather during the growing season, and the composition of the soil. Any given vegetable oil therefore does not always have a specific or unique structure. Vegetable oil structures are therefore typically based on statistical averages. For example soybean oil contains a mixture of stearic acid, oleic acid, linoleic acid, and linolenic acid in the ratio of about 15:24:50:11, which corresponds to an average molecular weight of approximately 800-860 daltons and an average number of double bonds of 4.4-4.7 per triglyceride. One method of quantifying the number of double bonds is the iodine value (IV), which is defined as the number of grams of iodine that will react with 100 grams of vegetable oil. The average iodine value of soybean oil therefore ranges from about 120 to about 140.

The term “soybean oil” is well known in the art, and refers to a vegetable oil extracted from the seeds of the soybean (Glycine max). Soybean oil consists of triglyceride molecules with, on average, about 4.5 carbon-carbon double bonds per molecule in the fatty acid side chains. A 100 g sample of soybean oil has about 16 g of saturated fat, about 23 g of mono unsaturated fat, and about 58 g of poly unsaturated fat. The unsaturated fatty acids in soybean oil triglycerides can include about 1-10% alpha-linolenic acid (C-18:3); 49-53% linoleic acid (C-18:2); and 21-25% oleic acid (C-18:1). Soybean oil can also contains the long chain saturated fatty acids stearic acid (˜4%) and palmitic acid (˜10%).

The term “methoxylated soybean oil polyol” (MSOL) refers to a soybean oil wherein olefin groups have been epoxidized and ring-opened with methanol to provide the methoxylated soybean oil polyol having OH numbers (mg KOH/g) in the range of about 130-210. For example, the number of hydroxyl groups in MSOL-135 is about 2.4 per triglyceride. Methoxylated soybean oil polyols (MSOLs) with hydroxyl numbers of 135, 149 and 176 mg KOH/g were prepared according to the procedure of Example 1.

The term “latex” refers to a stable emulsion of polymer microparticles in an aqueous medium. The term “latex” or “latex emulsion” by definition includes both latex particulates as well as the aqueous medium in which the latex particulates are dispersed. The term “latex particulates” or “latex particles” are the polymeric masses, such as those described herein, that are dispersed in the latex emulsion.

The waterborne polyurethane dispersions described herein can be used to form latex emulsions. Drying the emulsions results in a latex polymer. A “latex polymer” or “film-forming latex polymer” (used interchangeably herein) refers to a high molecular weight, film-forming component, which imparts water resistance and durability to the dry coating film. Latex polymers of the invention include the polymerization and co-polymerization products of polyurethane dispersions described herein and vinyl monomers. In some embodiments, the vinyl monomers can include, for example, vinyl acetate, acrylic acid, methacrylic acid, styrene, alpha-methyl styrene, butadiene, acrylates, methacrylates, vinyl chloride, vinylidene chloride and acrylonitrile containing monomers.

The term “divinyl crosslinker” refers to a organic compound that includes at least two vinyl groups that can be used to crosslink olefin-containing polymers. Examples of divinyl crosslinkers include diethylene glycol dimethyl methacrylate, divinyl benzene, 1,12-dodecanediol dimethacrylate; 1,3-butylene glycol diacrylate; 1,3-butylene glycol dimethacrylate; 1,4-butanediol diacrylate; 1,4-butanediol dimethacrylate; 1,6-hexanediol diacrylate; 1,6-hexanediol dimethacrylate; an acrylate ester; an alkoxylated aliphatic diacrylate; an alkoxylated hexanediol diacrylate; an alkoxylated hexanediol diacrylate; an alkoxylated neopentyl glycol diacrylate; cyclohexane dimethanol diacrylate; cyclohexane dimethanol dimethacrylate; diethylene glycol diacrylate; diethylene glycol dimethacrylate; dipropylene glycol diacrylate; ethoxylated (10) bisphenol A diacrylate; ethoxylated (2) bisphenol A dimethacrylate; ethoxylated (3) bisphenol A diacrylate; ethoxylated (30) bisphenol A diacrylate; ethoxylated (30) bisphenol A dimethacrylate; ethoxylated (4) bisphenol A diacrylate; ethoxylated (4) bisphenol A dimethacrylate; ethoxylated (8) bisphenol A dimethacrylate; ethoxylated (3) bisphenol A dimethacrylate; ethoxylated (10) bisphenol dimethacrylate; ethoxylated (6) bisphenol A dimethacrylate; ethylene glycol dimethacrylate; neopentyl glycol diacrylate; neopentyl glycol dimethacrylate; polyester diacrylate; polyethylene glycol (200) diacrylate; polyethylene glycol (400) diacrylate; polyethylene glycol (400) dimethacrylate; polyethylene glycol (600) diacrylate; polyethylene glycol (600) dimethacrylate; polyethylene glycol (1000) dimethacrylate; polyethylene glycol dimethacrylate; polypropylene glycol (400) dimethacrylate; propoxylated (2) neopentyl glycol diacrylate; tetraethylene glycol diacrylate; tetraethylene glycol dimethacrylate; tricyclodecane dimethanol diacrylate; triethylene glycol diacrylate; triethylene glycol dimethacrylate; tripropylene glycol diacrylate; ethoxylated (3) trimethylolpropane triacrylate; ethoxylated (6) trimethylolpropane triacrylate; ethoxylated (9) trimethylolpropane triacrylate; ethoxylated (15) trimethylolpropane triacrylate; ethoxylated (20) trimethylolpropane triacrylate; highly propoxylated (5.5) glyceryl triacrylate; low viscosity trimethylolpropane triacrylate; pentaerythritol triacrylate; propoxylated (3) glyceryl triacrylate; propoxylated (3) trimethylolpropane triacrylate; propoxylated (6) trimethylolpropane triacrylate; trimethylolpropane triacrylate; trimethylolpropane trimethacrylate; tris (2-hydroxy ethyl) isocyanurate triacrylate; di-trimethylolpropane tetraacrylate; dipentaerythritol pentaacrylate; ethoxylated (4) pentaerythritol tetraacrylate; low viscosity dipentaerythritol pentaacrylate; a pentaacrylate ester; pentaerythritol tetraacrylate; or combinations thereof. Such divinyl compounds can be obtained from, for example, Sartomer USA, LLC (Exton, Pa.).

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1

### Preparation of Methoxylated Soybean Oil Polyols (MSOLs)

Inexpensive, readily available vegetable oil-based polyols are good candidates for the synthesis of environmentally-friendly, waterborne polyurethane dispersions from renewable raw materials, but they also face an important challenge when employing polyols with high hydroxyl functionality. The high functionality of some of these polyols can lead to gelation and higher crosslinking and, therefore, present potential difficulties in dispersing the resulting highly crosslinked PU prepolymers into water. Therefore, only soybean oil-based polyols with a relatively low average hydroxyl functionality of about 2.3 have previously been successfully used for the synthesis of waterborne PU dispersions. To significantly enlarge the potential applications of vegetable oils as raw materials for the development of waterborne PUs with high performance, the successful utilization of highly functionalized vegetable oil-based polyols and the resulting vegetable oil-based waterborne PU dispersions are needed.

A series of soybean oil-based polyols with average hydroxyl functionality ranging from 2.4 to as high as 4.0 have been prepared by the ring-opening of epoxidized soybean oils with methanol, as described below. These products have been successfully used to synthesize environmentally-friendly, soybean oil-based waterborne polyurethanes with high performance properties, for use in preparing hybrid latexes, as described below in Examples 2 and 3.

Materials. Wesson soybean oil was purchased at a local supermarket and used directly without further purification. Isophorone diisocyanate (IPDI) and dimethylol propionic acid (DMPA) were purchased from Aldrich Chemical Company. Hydrogen peroxide (30%), formic acid (88%), triethylamine (TEA), magnesium sulfate, methyl ethyl ketone (MEK), and ethyl acetate were purchased from Fisher Scientific Company. Materials were used as received without further purification.

Synthesis of the Epoxidized Soybean Oils and Polyols. Epoxidized soybean oils (ESOs) with differing numbers of epoxide groups were prepared by reaction of the unsaturation sites of the soybean oil with a mixture of formic acid and hydrogen peroxide according to a literature procedure (Khot et al., J. Appl. Polym. Sci. 2001, 82, 703-723). In brief, soybean oil (100 g) was added to a 500 mL flask, then certain amounts of 30% hydrogen peroxide were added, followed by the addition of formic acid under vigorous stirring. The weight ratio between the hydrogen peroxide and the formic acid was held at 0.9:1. The reaction was carried out at room temperature for 24 h. Then, 150 mL of ethyl acetate and 100 mL of distilled water were added, resulting in two layers. The organic layer was washed with aqueous sodium bicarbonate solution, until a slightly alkaline pH was obtained, and the organic layer was then dried over MgSO₄ and filtered. Finally, the clear viscous epoxidized soybean oils were obtained after removal of the organic solvent under vacuum.

By adjusting the molar ratio of the hydrogen peroxide and the carbon-carbon double bonds in the triglyceride from 2.5 to 3.0, 3.4, 4.1 and 5.0, epoxidized soybean oils averaging 2.0 to 2.3, 2.7, 3.1 and 3.7 epoxide groups per triglyceride (as determined by ¹H NMR spectroscopy; Varian Associates, Palo Alto, Calif.) have been successfully obtained. ¹H NMR (CDCl₃): δ 0.8-1.1 (CH₃of the fatty acids), 1.2-1.8 (CH₂ of the fatty acids), 1.9-2.4 (—CH₂C═O—), 2.7 (—C═C—CH₂—C═C—), 2.8-3.2 (—CH of the oxirane rings), 4.1-4.3 (—CH₂—O—C═O), 5.2-5.6 (—CH═CH—).

The methoxylated soybean oil polyols (MSOLs) were prepared by the ring opening of ESO with methanol (see related techniques described by Guo et al., J. Polym. Sci. Part A: Polym. Chem. 2000, 38, 3900-3910). Briefly, methanol (100 g), water (10 g), isopropanol (100 g) and fluoroboric acid (48% in water, 4.0 g) were mixed in a flask equipped with a magnetic stirrer and a dropping funnel. The resulting mixture was maintained at 40° C. and stirred vigorously, while the epoxidized soybean oil (100 g) was added dropwise. The reaction mixture was stirred for an additional 2 h at 50° C., at which time ammonia (30% in water, 6 mL) was added to quench the reaction. After purification using the same methods used for the epoxidized soybean oil mentioned above, the clear and viscous polyols with different hydroxyl numbers were obtained. The OH number of the MSOL was determined according to the Unilever method (see Lligadas et al., Biomacromolecules 2007, 8, 686-692) and the results are collected in Table 1-1.

TABLE 1-1
General properties of methoxylated soybean oil polyols (MSOLs).

| | OH | | | | Physical |
|---|---|---|---|---|---|
| | number | Equivalent | | | state at |
| | (mg | weight (g/ | Hydroxyl | | room |
| Polyol | KOH/g) | equivalent) | functionality | M_{w} | temperature |
| MSOL-135 | 135 | 417 | 2.4 | 1030 | Liquid |
| MSOL-149 | 149 | 375 | 2.8 | 1045 | Liquid |
| MSOL-176 | 176 | 318 | 3.3 | 1050 | Liquid |
| MSOL-190 | 190 | 295 | 3.7 | 1091 | Liquid |
| MSOL-200 | 200 | 282 | 4.0 | 1126 | Liquid |

### Example 2

### Preparation of Soybean-Oil-Based Waterborne Polyurethane Dispersions

Soybean-oil-based waterborne polyurethane (SPU) dispersions were prepared as illustrated in Scheme 2-1.

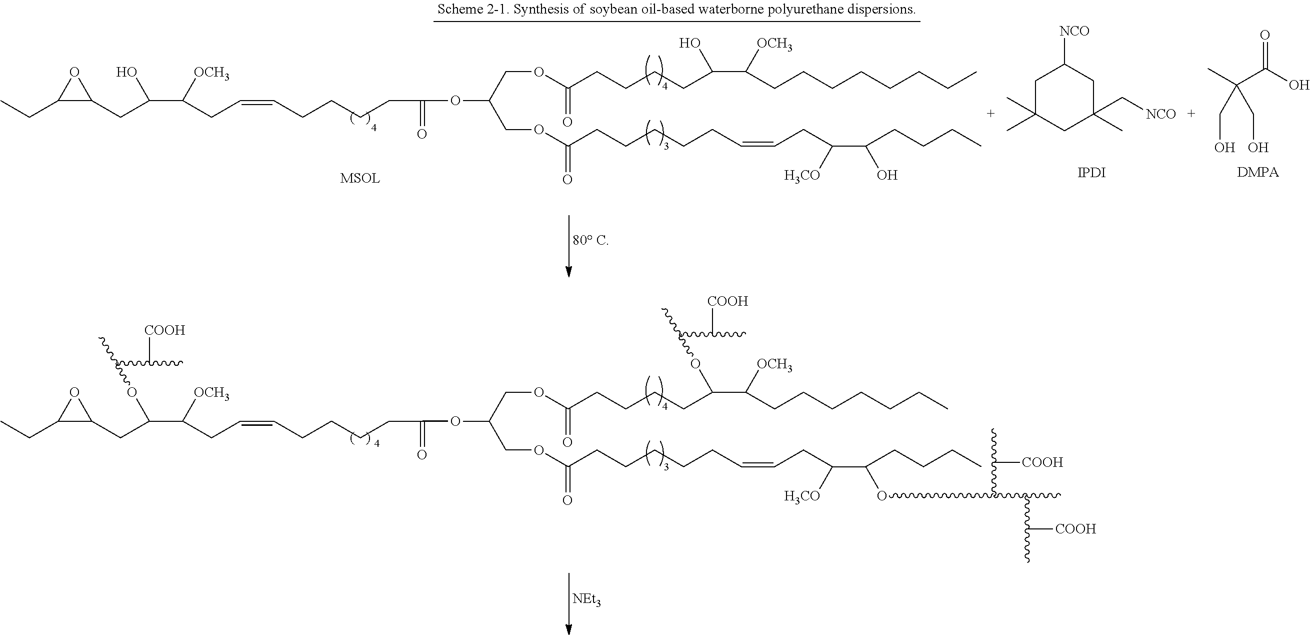

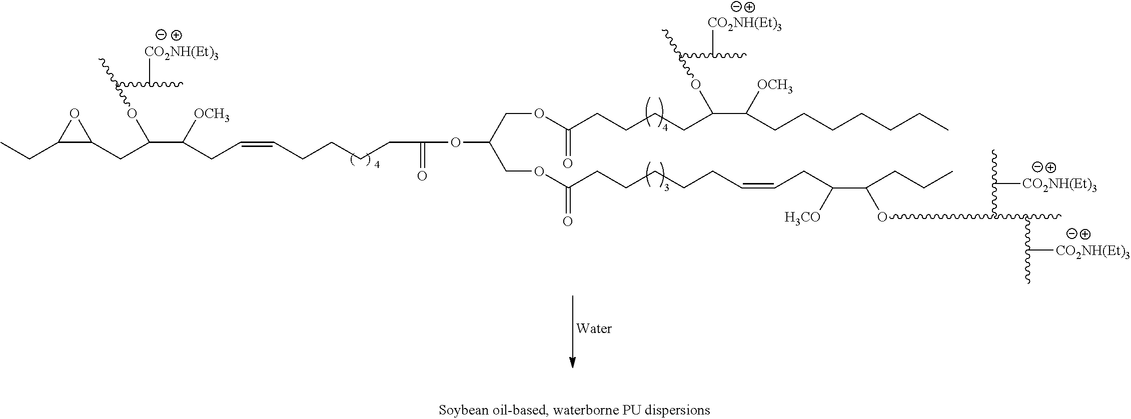

The MSOL (15 g), IPDI and DMPA were added to a four-necked flask equipped with a mechanical stirrer, nitrogen inlet, condenser and thermometer. The molar ratio between the NCO groups of the IPDI, the OH groups of the MSOL and the alcohol OH groups of the DMPA is summarized in Table 2-1.

TABLE 2-1
Chemical composition, soluble fraction (SF)
and crosslink density of the SPU films.

| | Molar ratio^{a} | | | | | | νₑ |
|---|---|---|---|---|---|---|---|
| | NCO | | | HS^{c} | DMPA | SF | (mol/ |
| Sample | (IPDI) | OH^{a} | OH^{b} | (wt. %) | (wt. %) | (%) | m³) |
| SPU-135 | 1.7 | 1.0 (135) | 0.69 | 39.3 | 5.0 | 30.4 | 67 |
| SPU-149 | 1.7 | 1.0 (149) | 0.69 | 41.9 | 5.4 | 23.3 | 69 |
| SPU-149I | 1.85 | 1.0 (149) | 0.84 | 44.8 | 6.4 | 19.4 | 73 |
| SPU-149II | 2.0 | 1.0 (149) | 0.99 | 47.4 | 6.9 | 17.9 | 70 |
| SPU-176 | 1.7 | 1.0 (176) | 0.69 | 45.8 | 5.9 | 22.4 | 85 |
| SPU-190 | 1.7 | 1.0 (190) | 0.69 | 47.8 | 6.1 | 21.6 | 116 |
| SPU-200 | 1.7 | 1.0 (200) | 0.69 | 49.0 | 6.3 | 18.9 | 127 |

^{a}Hydroxyl molar ratio of the MSOL (number in parentheses denotes the MSOL OH number).
^{b}Hydroxyl molar ratio of the DMPA.
^{c}Hard segment content = Mass (IPDI + DMPA + TEA)/Mass (MSOL + IPDI + DMPA + TEA).

The reaction was carried out at 78° C. for 1 h under a dry nitrogen atmosphere and 30 g of methyl ethyl ketone (MEK) was then added to reduce the viscosity of the system. After an additional 2 h reaction, the reactants were cooled to about 40° C. and then neutralized by the addition of TEA (1.2 equivalents per DMPA), followed by dispersion at high speed with distilled water to produce the SPU dispersions with a solid content of about 20 wt. % after removal of the MEK under vacuum.

Two groups of SPU dispersions were prepared. In one, a constant ratio was maintained between the diisocyanate, the polyol and the DMPA (entries 1, 2, 5, 6 and 7 in Table 2-1), leading to SPUs with an increased polyol functionality. In the other, the molar ratio of the three components was varied (entries 3, 4 and 5 in Table 2-1), affording SPUs with the same polyol functionality, but different hard segment content. The corresponding SPU films were obtained by drying the SPU dispersions at room temperature in a glass mold. Characterization of the compositions is further described by Lu and Larock (Biomacromolecules 2008, 9, 3332-3340).

### Example 3

### Core-Shell Hybrid Latexes

Surfactant-free core-shell hybrid latexes can be readily prepared from soybean oil-based waterborne polyurethanes and poly(styrene-butyl acrylate), as described herein. Conventional emulsion polymerization is carried out using traditional low molecular weight surfactants, which are able to migrate to the polymer surface, resulting in delamination and corrosion. Waterborne polyurethanes are an interesting polymeric material, in which a hydrophilic segment of polyurethane (PU) acts as an internal emulsifier, allowing self-emulsification. Soybean oil-based waterborne PU dispersions have been successfully prepared using methoxylated soybean oil polyol (MSOL) with OH functionality ranging from approximately 2.4 to as high as 4.0 (Biomacromolecules 2008, 9, 3332-3340). The, novel SPU films, which result from drying, exhibit thermophysical and mechanical properties that are comparable to those of PUs from petroleum-based polyols.

This example describes the preparation of novel soybean oil-based waterborne PU/polystyrene-butyl acrylate (ST-BA) hybrid latexes via emulsion polymerization utilizing self-emulsification of the PU, instead of traditional surfactants. A variety of new soybean oil-based waterborne PU/poly(ST-BA) latexes with core-shell structures have been synthesized by polymerization of vinyl monomers (e.g. styrene and butyl acrylate) in the presence of soybean oil-based waterborne polyurethane dispersions using MSOLs as the starting materials. The polymerization kinetics, the morphology and particle size of the latexes, and the thermal and mechanical properties of the resulting films have been thoroughly investigated.

Materials. Wesson soybean oil was purchased at the local supermarket and used directly without further purification. Methoxylated soybean oil polyols (MSOLs) with hydroxyl numbers of 135, 149 and 176 mg KOH/g were prepared according to Example 1 above. Isophorone diisocyanate (IPDI), dimethylol propionic acid (DMPA), styrene (ST) and butyl acrylate (BA) were purchased from Sigma-Aldrich (Milwaukee, Wis.). Sodium hydroxide, methanol, hydrogen peroxide (30%), potassium persulfate (KPS), formic acid (88%), triethylamine (TEA), magnesium sulfate, methyl ethyl ketone (MEK), and ethyl acetate were purchased from Fisher Scientific Company (Fair Lawn, N.J.). Diethylene glycol dimethacrylate (DGDM) was obtained from Sartomer USA, LLC. All materials were used as received without further purification.

Synthesis of the SPU dispersions. The MSOL (15 g), IPDI and DMPA were added to a four-necked flask equipped with a mechanical stirrer, nitrogen inlet, condenser and thermometer. The molar ratio of the NCO groups of the IPDI, the OH groups of the MSOL and the OH alcohol groups of the DMPA was held at 2.0:1.0:0.95. The reaction was carried out at 78° C. for 1 h under a dry nitrogen atmosphere and then 30 g of MEK was added to reduce the viscosity of the system. After an additional 2 h reaction, the reactants were cooled to about 40° C. and then neutralized by the addition of TEA (1.2 equivalents per DMPA), followed by dispersion at high speed with distilled water, to produce the SPU dispersions with a solid content of about 20 wt. % after removal of the MEK under vacuum.

Synthesis of the SPU/poly(ST-BA) core-shell hybrid latexes. The preparation of the hybrid latexes is illustrated in Scheme 3-1.

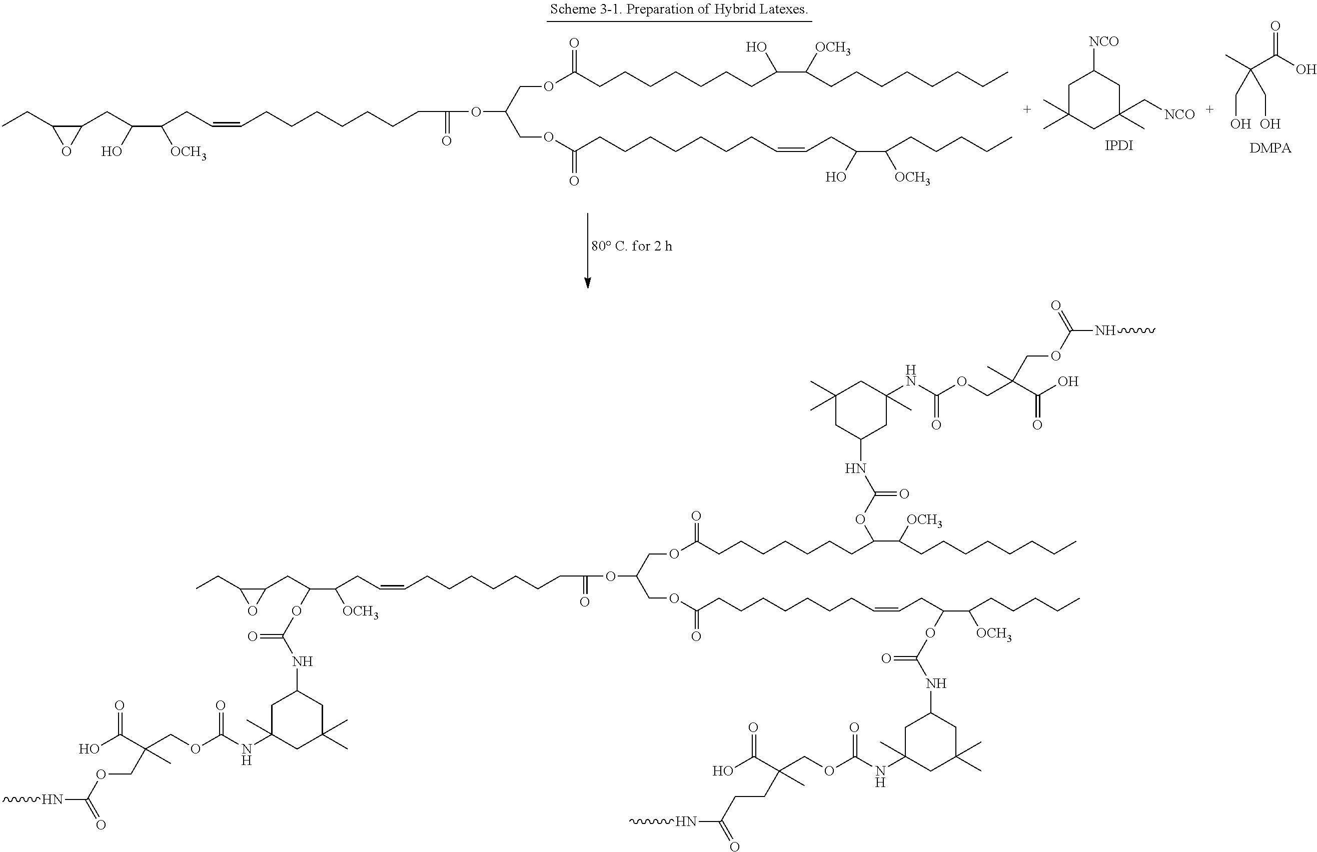

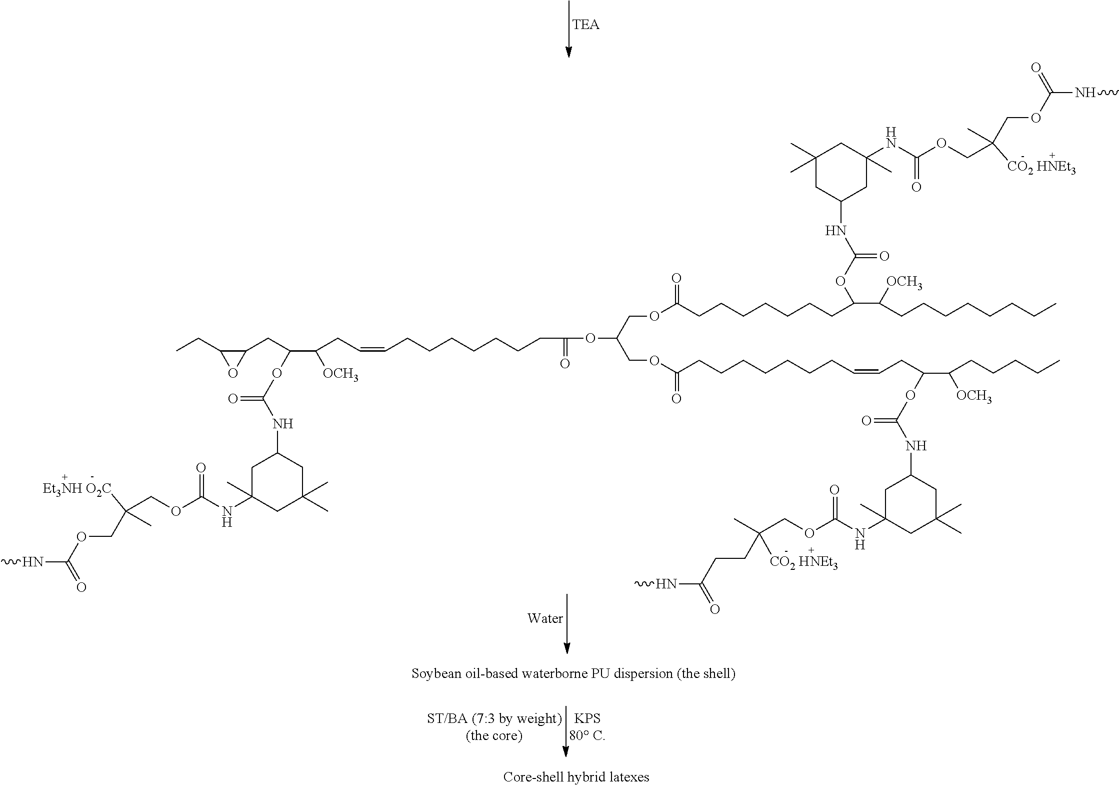

The desired amount of ST and BA in a ratio of 70:30 by weight was added to the SPU dispersion. The resulting reactants were stirred at room temperature under an N₂ atmosphere for 2 h, and then brought to the polymerization temperature of 80° C. for 4 h to obtain the hybrid emulsion, using K₂S₂O₈ (KPS) (0.5 wt % based on vinyl monomers) as an initiator. During the polymerization, approximately 5 g portions of the emulsion were taken out by a syringe at intervals and injected into a Petri dish containing 0.5% hydroquinone solution in an ice bath. Monomer conversion was determined gravimetrically from these samples.

By changing the weight ratio of the PU and vinyl monomers from 100:0 to 90:10, 80:20, 70:30, 60:40, 50:50, and 40:60, a series of SPU/poly(ST-BA) hybrid latexes were successfully prepared. The crosslinker diethylene glycol dimethyl methacrylate (DGDM) was added to provide SPU135-30 [70 wt. % SPU135 and 30 wt. % poly(ST-BA)] to increase the crosslink density of the poly(ST-BA) core, while MSOL 149 and MSOL 176 were used to prepare SPU shells with higher crosslink densities. The samples and their compositions are summarized in Table 3-1.

TABLE 3-1
Chemical composition of various core-shell latexes.

| | | | SPU | Poly(ST-BA) | DGDM |
|---|---|---|---|---|---|
| | | OH number of | content | content | content |
| Entry | Sample | the polyol | (wt. %) | (wt. %) | (wt. %) |
| 1 | SPU135 | 135 | 100 | 0 | 0 |
| 2 | SPU135-10 | 135 | 90 | 10 | 0 |
| 3 | SPU135-20 | 135 | 80 | 20 | 0 |
| 4 | SPU135-30 | 135 | 70 | 30 | 0 |
| 5 | SPU135-40 | 135 | 60 | 40 | 0 |
| 6 | SPU135-50 | 135 | 50 | 50 | 0 |
| 7 | SPU135-60 | 135 | 40 | 60 | 0 |
| 8 | SPU135-29-1 | 135 | 70 | 29 | 1 |
| 9 | SPU135-27-3 | 135 | 70 | 27 | 3 |
| 10 | SPU149-30 | 149 | 70 | 30 | 0 |
| 11 | SPU176-30 | 176 | 70 | 30 | 0 |

The nomenclature for the samples is as follows: a hybrid latex prepared from MSOL 135 containing 27 wt. % of poly(ST-BA) and 3 wt. % of crosslinker DGDM is designated as SPU135-27-3. Films were prepared by drying the emulsions at room temperature in a glass mold.

Characterization. The morphology of the latex particles was observed on a transmission electron microscope (JEOL 1200EX). The emulsions prepared were diluted with deionized water to about 0.4 wt. %. One drop of the diluted emulsion was placed on the coated side of a 200-mesh nickel grid in a Petri dish. After drying, the samples were characterized. Differential scanning calorimetry (DSC) was performed on a thermal analyzer (TA instrument Q20). The samples were heated from room temperature (˜23° C.) to 100° C. at 20° C./min to erase any thermal history, equilibrated at −70° C., and then heated again to 100° C. at 10° C./min. The glass transition temperature (T_{g}) of the samples was determined from the midpoint temperature in the heat capacity change of the second DSC scan. Samples of ˜10 mg were cut from the films and used for analysis. A thermogravimeter (TA instrument TGA Q50, USA) was used to measure the weight loss of the SPU films under an air atmosphere. The samples were heated from 100 to 650° C. at a heating rate of 20° C./min. Generally, 10-15 mg samples were used for the thermogravimetric analysis.

The mechanical properties of the latex films were determined using an Instron universal testing machine (model 4502) with a crosshead speed of 100 mm/min. Rectangle specimens of 80 mm×10 mm (length x width) were used. An average value of at least five replicates of each material was taken.

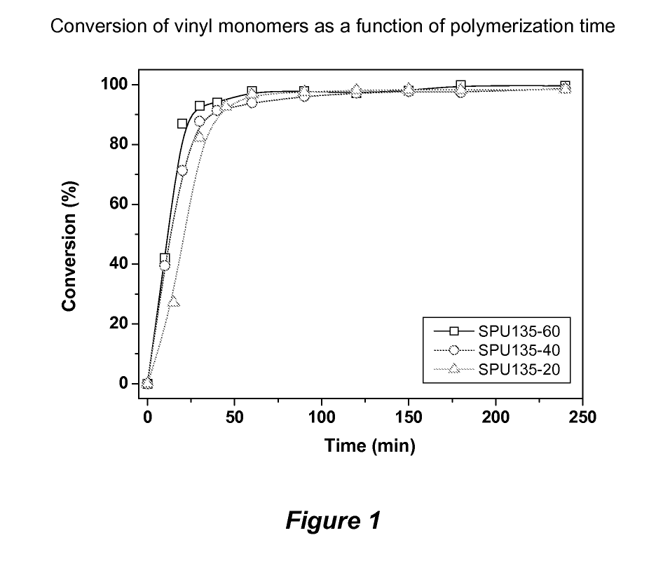

Results. Monomer conversion and particle size. The conversion-time profiles for the seeded surfactant-free emulsion polymerization at 80° C. are shown in FIG. 1. The copolymerization rate of the hybrid latex increased when the monomer content of ST and BA was increased. Some impurities in the PU resin may inhibit polymerization or the resin itself may reduce the polymerization rate by diluting the monomer concentration and promoting resin chain transfer.

To maintain preferred particle size, the ST/BA content can be limited to less than about 60 wt. % in the PU dispersions. An ST/BA content of greater than about 60 wt. % in the PU dispersions can lead to larger particle sizes, which can lead to decreased emulsion stability. For the hybrid latexes evaluated herein, greater than 98% of the monomers (≧99.5% from HPLC) were polymerized after 2 h, which is in accord with conventional polymerization theory.

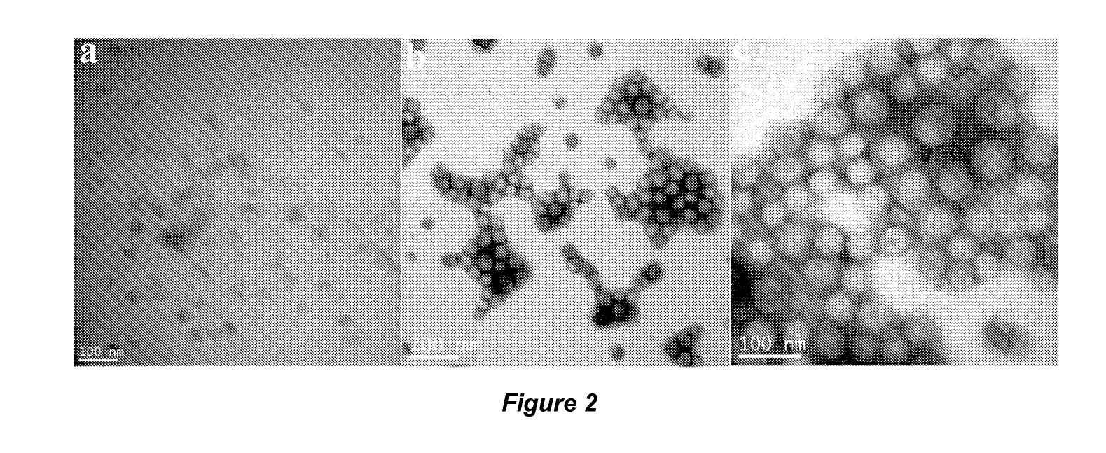

TEM images of the soybean oil-based PU dispersion and the corresponding hybrid latex with 40 wt. % vinyl monomers are presented in FIG. 2. The PU dispersion shows a uniform particle size of about 30 nm diameter. Soybean oil includes triglyceride molecules with, on average, approximately 4.5 carbon-carbon double bonds per molecule in the fatty acid side chains. The number of hydroxyl groups in MSOL-135 is about 2.4 per triglyceride and approximately 2.1 carbon-carbon double bonds in the fatty acid chains of the triglyceride.

The residual carbon-carbon double bonds in MSOL-135 can be stained by OsO₄, resulting in a darker SPU phase in the SPU/acrylics hybrid latex. However, for the SPU/poly(ST-BA) hybrid latex, the carbon-carbon double bonds in the benzene ring of ST can also be stained by OsO₄. To eliminate the effect of the benzene rings, the hybrid latex for TEM observation was synthesized using methyl methacrylate (MMA), instead of ST, and the same stoichiometry as the PU/poly(ST-BA), namely 60:40. As shown in the TEM images, a significant increase in the particle size from 30 to 50 nm diameter is observed for the hybrid latex with 40 wt. % vinyl monomers when compared with that of the PU dispersion. Furthermore, the hybrid latex exhibits a clear core-shell structure, where the SPU forms the darker region of the outer layer, while the vinyl polymer forms the lighter region in the core. The mechanism for formation of the emulsion particles involves a phase inversion process. The more hydrophilic chains in the amphiphilic hybrid latex system are selectively located in the shell region and the hydrophobic chains are concentrated in the core region of the latex particles during the course of this phase inversion process.

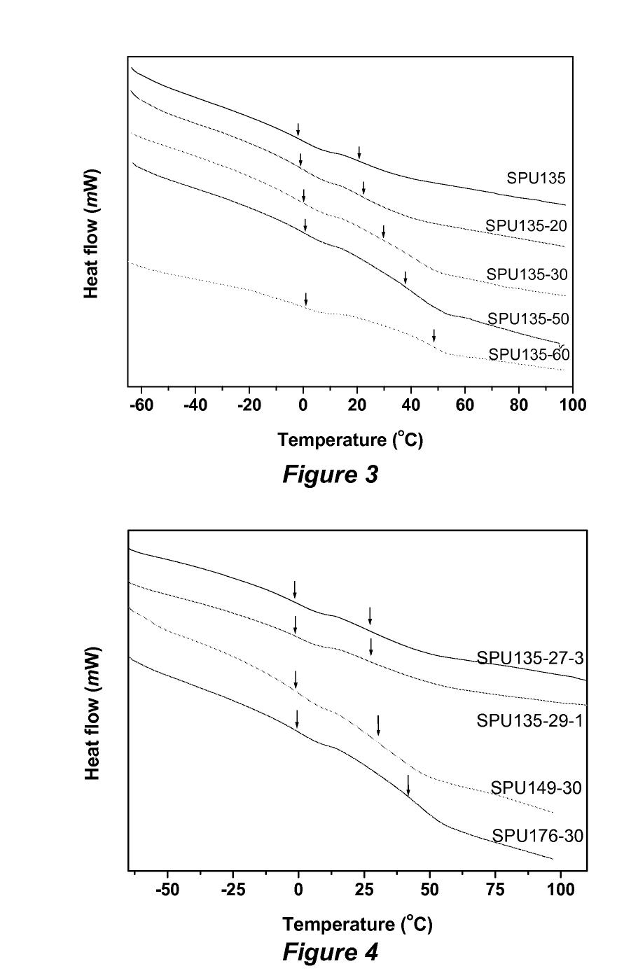

Thermal properties. FIG. 3 shows the second heating DSC thermograms of the PU and core-shell hybrid latex films with 20, 30, 50 and 60 wt. % poly(ST-BA). No melting or crystallization peaks were found by DSC, indicating the amorphous nature of this bio-based PU. Two glass transitions are observed for the seed SPU film, in which the transitions at -2 and 21° C. are attributed to the soft segment glass transition temperature (T_{g1}) and a hard segment glass transition temperature (T_{g2}) respectively. This indicates a phase-separated morphology for the seed SPU film. With an increase in poly(ST-BA) content, the T_{g}s of the core-shell latex films are shifted with respect to the pure SPU from −1.8 to 1.6° C. for T_{g1} and 20.9 to 47.9° C. for T_{g2}. The shifts are the result of partial compatibility and interdiffusion of the shell SPU and core poly(ST-BA) components and indicate some degree of miscibility. Similar results have been reported by Chai et al. for a PPG-based polyurethane/polyacrylate core-shell latex system.

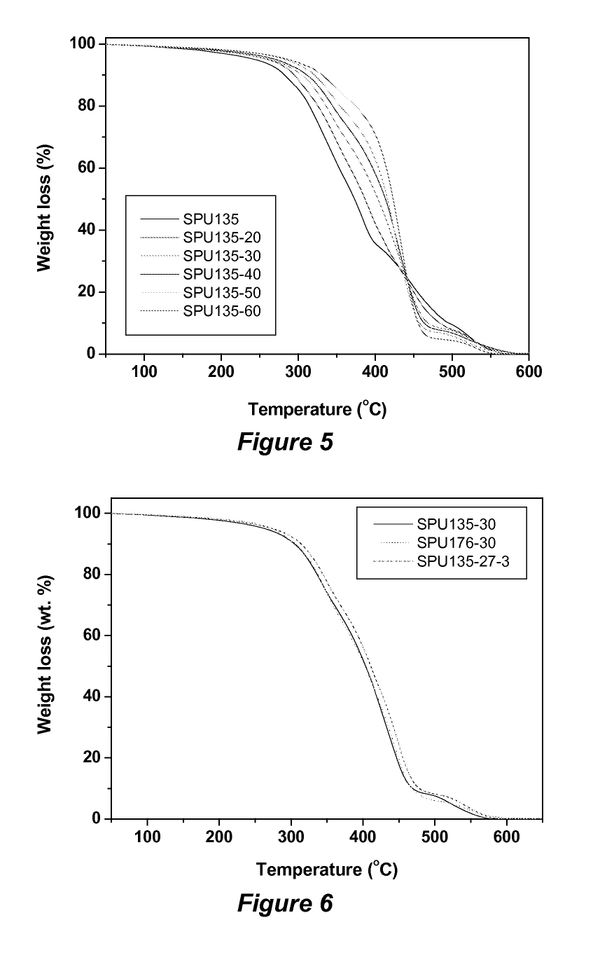

To investigate the crosslinking effect of the shell PU component on the thermophysical properties, core-shell latex films with a 70 wt. % shell PU component have been prepared from MSOLs with OH numbers of 135, 149 and 176 mg KOH/g, respectively. The corresponding DSC thermograms are shown in FIG. 4. Similar to the core-shell latexes from MSOL-135, phase separation is also observed in the core-shell latexes from MSOL-149 and MSOL-176. However, the T_{g2} value, assigned to the hard segment, shifts to a higher temperature, from 24.3 to 44.9° C., as a result of increased crosslinking of the SPU shell. For the core-shell latexes prepared from MSOL-135 and poly(ST-BA) with 0 to 3 wt % of the vinyl crosslinker DGDM, the T_{g2} value is slightly increased from 24.3 to 27.9° C. This can be explained by the fact that multifunctional vinyl monomers can increase the crosslink density of the poly(ST-BA) core. The thermal stabilities of the PUs and their core-shell hybrid latex films were evaluated by thermal gravimetric analysis (TGA) as shown in FIG. 5, the results of which are summarized in Table 3-2. Generally, PUs exhibit relatively poor thermal stabilities, due to dissociation of the urethane bond occurring around 200° C. The onset of urethane bond dissociation is somewhere <300° C., depending upon the type of isocyanate and polyol employed.

TABLE 3-2
Thermal analysis of the latex films.

| | | DSC | | TGA | |
|---|---|---|---|---|---|
| Entry | Sample | T_{g1}/° C. | T_{g2}/° C. | T₅/° C. | T₅₀/° C. |
| 1 | SPU135 | −1.8 | 20.9 | 242 | 373 |
| 3 | SPU135-20 | −1.0 | 22.2 | 260 | 387 |
| 4 | SPU135-30 | 0.4 | 24.3 | 263 | 403 |
| 5 | SPU135-40 | 0.8 | 38.2 | 271 | 413 |
| 6 | SPU135-50 | 1.2 | 42.6 | 282 | 416 |
| 7 | SPU135-60 | 1.6 | 47.9 | 287 | 423 |
| 8 | SPU149-30 | 0.4 | 30.3 | 257 | 406 |
| 9 | SPU176-30 | 0.6 | 44.9 | 274 | 403 |
| 10 | SPU135-29-1 | 0.2 | 26.3 | 269 | 405 |
| 11 | SPU135-27-3 | 0.3 | 27.9 | 274 | 410 |

This analysis showed that the PU films undergo more than one thermal degradation process. The degradation of the PU films that is observed in the range of 150-300° C. can be attributed to decomposition of the urethane bonds, which takes place through dissociation to an isocyanate and an alcohol, the formation of primary amines and olefins, or the formation of secondary amines, which results in the loss of carbon dioxide from the urethane bond. The degradation processes in the temperature range of 300-400° C. are attributed to soybean oil chain scission. The last steps in the weight-loss rate, centered at a temperature of ˜520° C., correspond to thermo-oxidative degradation of the films. For the core-shell latexes, the TGA curves below 450° C. shift to a higher temperature when compared with the pure PU, indicating a higher thermal stability for the core-shell latexes.

The interesting parameters for the thermal stability of the core-shell latexes have been taken from the onset of degradation, which is usually taken as the temperature at which 5% degradation occurs (T₅) and the midpoint temperature of the degradation (T₅₀). The thermal degradation behavior of the core-shell latexes is largely influenced by the poly(ST-BA) resin content. Increases in the T₅ value from 242 to 287° C. and the T₅₀ value from 373 to 423° C. are observed for the hybrid latexes with an increase in the poly(ST-BA) content from 0 to 60 wt. %. These results indicate that the vinyl monomers play an important role in enhancing the thermal stability of the core-shell hybrid latexes. The improved thermal stability of the core-shell latexes can be explained by the occurrence of extensive grafting, crosslinking, and interpenetration between the PU and the poly(ST-BA).

FIG. 6 shows the TGA curves of the core-shell latex films prepared from two polyols with different hydroxyl number and vinyl monomers with different amounts of crosslinker. When compared with the core-shell latex film from MSOL-135, no significant difference is observed in the TGA curve for the core-shell latex from MSOL-176. This can be explained by the higher content of labile hard segments incorporated into the PU shell to compensate for the higher OH number of the MSOL. However, the core-shell latex film with 3 wt. % of the crosslinker DGDM exhibits a significant increase in the thermal stability, due to higher crosslinking in the poly(ST-BA) core.

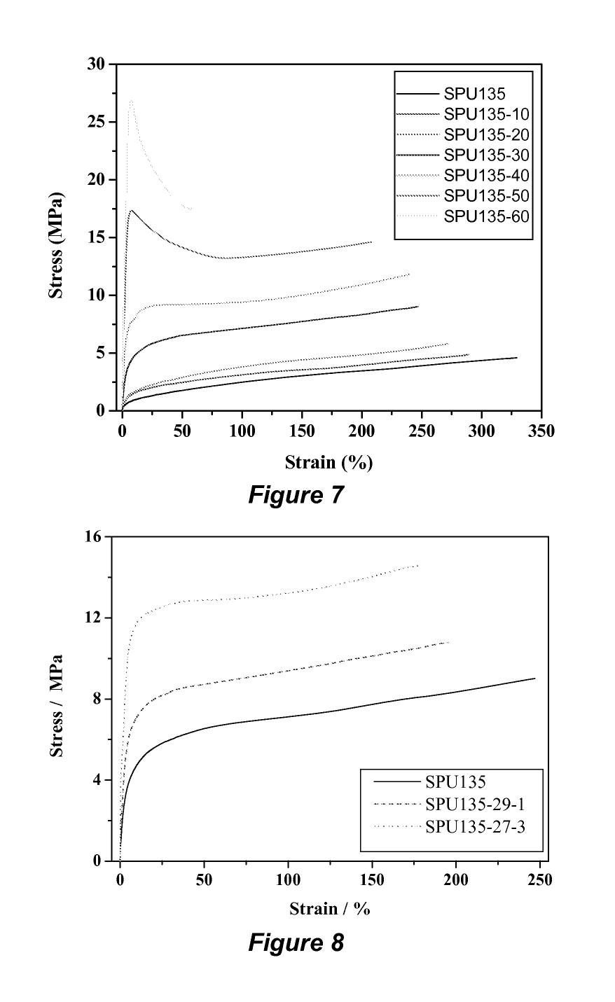

Mechanical properties. Table 3-3 summarizes the Young's moduli, tensile strengths, and elongation at break values for the SPU film from MSOL-135 and their core-shell latex films, and typical tensile stress—strain behaviors are shown in FIG. 7.

TABLE 3-3
Mechanical properties of the SPUs and their core-shell latexes.

| | | Young's modulus | Tensile | Elongation at |
|---|---|---|---|---|
| Entry | Sample | (MPa) | strength (MPa) | break (%) |
| 1 | SPU135 | 9.6 ± 3.8 | 4.5 ± 0.6 | 329.6 ± 47.2 |
| 2 | SPU135-10 | 22.2 ± 5.2 | 4.9 ± 0.2 | 281.3 ± 13.3 |
| 3 | SPU135-20 | 33.8 ± 7.3 | 5.7 ± 0.2 | 258.6 ± 14.5 |
| 4 | SPU135-30 | 177.3 ± 13.6 | 8.7 ± 0.4 | 233.3 ± 11.9 |
| 5 | SPU135-40 | 362.6 ± 25.5 | 10.3 ± 1.3 | 218.4 ± 23.0 |
| 6 | SPU135-50 | 633.7 ± 53.1 | 14.6 ± 0.6 | 179.7 ± 14.6 |
| 7 | SPU135-60 | 1003.4 ± 42.4 | 17.5 ± 1.1 | 88.9 ± 18.4 |
| 8 | SPU149-30 | 389.4 ± 47.2 | 14.3 ± 2.5 | 172.5 ± 50.0 |
| 9 | SPU176-30 | 695.3 ± 52.5 | 22.8 ± 1.9 | 101.4 ± 21.6 |
| 10 | SPU135-29-1 | 323.8 ± 13.7 | 11.4 ± 0.9 | 198.7 ± 10.2 |
| 11 | SPU135-27-3 | 411.3 ± 14.0 | 15.2 ± 0.9 | 189.2 ± 14.2 |

The SPU135 shows a rubbery modulus of 9.6 MPa, a viable ultimate tensile strength of about 4.5 MPa, and an elongation at break of about 329% (Table 3-3, entry 1). For the core-shell latex film SPU135-10, the Young's modulus and ultimate tensile strength obviously increases, but its elongation at break slightly decreases (Table 3-3, entry 2). Both SPU135 and SPU135-10 exhibit a strain recovery of 100% (determined using methods as described by Huang et al., Polymer 2002, 43, 2287-2294), because of their relatively low crosslink densities and T_{g}s. This behavior is similar to the tensile test behavior of an elastomeric polymer. However, the film SPU135-40 exhibits behavior that is typical of a ductile plastic with a clear yield point and it exhibits a modulus and a tensile strength that are approximately 37 and 2.3 times higher, respectively, than those of SPU135.

A still higher poly(ST-BA) content results in a hard plastic SPU135-60 (FIG. 7), which exhibits yielding behavior, followed by strain softening, and no strain hardening behavior is observed before the specimen breaks. Its Young's modulus and ultimate tensile strength reach approximately 1003 MPa and 17.5 MPa (Table 3-3, entry 7), respectively. These changes in the mechanical behavior are a result of the increase in the rigid core in the resulting latex films.

The crosslinker DGDM has been incorporated into the poly(ST-BA) core to enhance the mechanical properties of the latex films obtained. The Young's modulus and tensile strength are increased to 411.3 MPa from 177.3 MPa and 15.2 MPa from 8.7 MPa, respectively, when the film contains 3 wt. % of the crosslinker DGDM in the core of the SPU135-30 film (Table 3-3, entry 11). The elongation at break of SPU135-27-3 was decreased to 189% from 233%, compared to SPU135-30. All of these changes result from the increased crosslink density in the poly(ST-BA) core. The stress-strain curves of SPU135-30, SPU135-29-1 and SPU135-27-3 are shown in FIG. 8, where they have similar tensile behaviors. Furthermore, the increase in the crosslink density in the SPU shell improves the latex films' mechanical properties as well.

The soybean-based polyols MSOL-149 and MSOL-176, with higher hydroxyl numbers compared to MSOL-135, have been used to prepare SPUs with higher crosslink densities. The Young's moduli of SPU149-30 and SPU176-30 are 389 MPa and 695 MPa, which are 2.2 and 3.9 times higher than the modulus for SPU135-30. Furthermore, the tensile strength increases to 14.3 MPa and 22.8 MPa from 8.7 MPa for SPU149-30 and SPU176-30, respectively. The elongation at break decreases, when the crosslink density of the SPU shell increases.

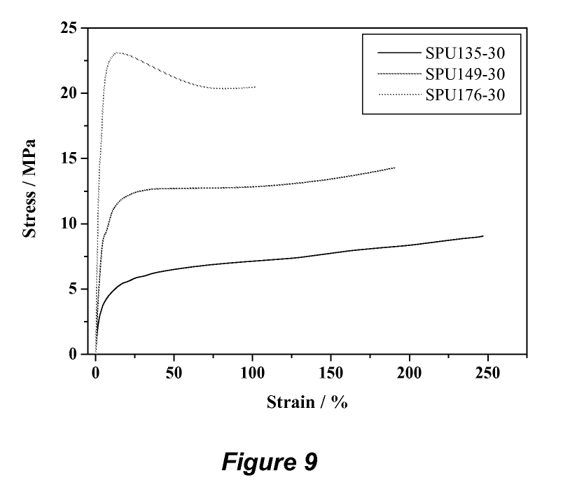

FIG. 9 illustrates the stress-strain curves for the films from SPU135-30, SPU149-30 and SPU176-30. Unlike the other two samples, SPU176-30 shows an obvious strain softening after the yield point. As discussed above, the increases in crosslink density in both the core and shell portions of the particles improve the mechanical properties of the final latex films dramatically.

Thus, surfactant-free core-shell hybrid latexes with waterborne soybean oil-based polyurethanes as the shell and poly(styrene-acrylate) as the core have been successfully prepared by seeded emulsion polymerization. The poly(styrene-acrylate) moiety can be, for example, 10-60 wt. % of poly(ST-BA). The crosslink densities of the polymers obtained have been controlled by using methoxylated soybean oil polyols with different hydroxyl numbers or adding a multifunctional vinyl crosslinker to the poly(ST-BA) core.

The structures and thermal and mechanical properties of the core-shell latexes and the resulting films have been thoroughly characterized. TEM images clearly show the formation of a core-shell structure in the hybrid latexes. The T_{g}s of the films obtained increase with incorporation of the poly(ST-BA), along with an increase in the crosslink densities in both the shell and core. Moreover, the core-shell hybrid latex films show a significant increase in their thermal stabilities, because of the incorporation of the more thermally stable poly(styrene-acrylate). Compared to the pure polyurethane films, the hybrid latex films' mechanical properties, namely their Young's moduli and tensile strengths, are enhanced significantly and they are further enhanced by an increase in the crosslink density of both the SPU shell and the poly(ST-BA) core. The properties of the latex films obtained range from elastomeric polymers to tough and hard plastics, due to grafting and crosslinking in the hybrid latexes, indicating that these coatings are very promising environmentally-friendly bioplastics with many potential applications, including applications as decorative and protective coatings.

### Example 4

### Coating Formulations

Coating formulations that include the core-shell hybrid latexes described herein can be prepared as follows. The core-shell latexes can be added to the following formulations as an aqueous emulsion containing, for example, about 45-50 weight percent solids.

Formulation 1. Wood Coating

| | | Amount | |
|---|---|---|---|
| Component | Material | (wt %) | Supplier |
| 1 | Core-Shell Latex | 72 | Described Herein |
| 2 | Tego Foamex 822 | 1.0 | Degussa |
| 3 | Tego Airex 902 W | 0.5 | Degussa |
| 4 | Butylcarbitol (BDG) | 4 | BASF |
| 5 | Dowanol DPM | 4 | Dow Chemical |
| 6 | Water | 12.4 | |
| 7 | Acematt TS 100 | 1 | Degussa |
| 8 | Ultralub E 612 | 4.5 | Keim Additec |
| 9 | Byk 346 | 0.3 | BYK Chemie |
| 10 | DSX 1514 | 0.3 | Cognis |
| | TOTAL | 100 | |

Premix Components 4-6 before combining with other Components.

Formulation 2. White Pigmented Wood Coating

| | | Amount | |
|---|---|---|---|
| Component | Material | (wt %) | Supplier |
| 1 | Core-Shell Latex | 55 | Described Herein |
| 2 | Tego Foamex 810 | 0.2 | Degussa |
| 3 | Tego Foamex 800 | 1.0 | Degussa |
| 4 | Byk 346 | 0.2 | BYK Chemie |
| 5 | Butylcellosolve (BG) | 2.5 | BASF |
| 6 | Dowanol DPnB | 3 | Dow Chemical |
| 7 | Lusolvan FBH | 1 | BASF |
| 8 | Water | 8 | |
| 9 | Acematt TS 100 | 1 | Degussa |
| 10 | Pigment Paste - White | 15 | [10-12% TiO₂] |
| 11 | Ropaque OP 3000 | 10 | Rohm & Haas |
| 12 | Luba Print 280/F | 3 | L. P. Bader |
| 13 | DSX 1514 | 0.1 | Cognis |
| | TOTAL | 100 | |

Premix Components 5-8 before combining with other Components.

Pigment Paste-White Composition

| | Amount | |
|---|---|---|
| Material | (wt %) | Supplier |
| Water | 15 | |
| Surfynol CT 231 | 7 | Air Products |
| Kronos 2190 | 77 | Kronos Titan Inc. |
| Tego Foamex 822 | 1.0 | Degussa |
| TOTAL | 100 | |

Various additives can also be included in the formulations. Examples of suitable additives or alternatives to the above additives include defoamers, substrate wetting agents, rheology control additives, matting agents, coalescing agents, and dispersants. Other suitable additives include protective colloids, fillers, coloring agents, antiseptics, biocides, dispersing agents, thickening agents, thixotropic agents, antifreezing agents, and pH adjusting agents, such as those described in U.S. Pat. No. 6,599,972 (Thames et al.), which is incorporated herein by reference.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A core-shell hybrid latex particle wherein the shell comprises a vegetable oil-based polyurethane and the core comprises a poly(acrylate)polymer, the vegetable oil-based polyurethane is crosslinked to the poly(acrylate)polymer, the particle has a diameter of about 30 nm to about 150 nm, and the particle comprises less than 1 wt. % surfactants.

2. The particle of claim 1 wherein vegetable oil moieties of the vegetable oil-based polyurethane are derived from almond oil, canola oil, castor oil, coconut oil, corn oil, cottonseed oil, flax seed oil, grape seed oil, hazelnut oil, linseed oil, olive oil, palm oil, palm kernel oil, peanut oil, rapeseed oil, rice bran oil, safflower oil, sesame oil, soybean oil, sunflower seed oil, or a combination thereof.

3. The particle of claim 2 wherein vegetable oil moieties of the vegetable oil-based polyurethane are derived from methoxylated vegetable oil polyols, ethoxylated vegetable oil polyols, epoxidized vegetable oil polyols, or a combination thereof.

4. The particle of claim 1 wherein the poly(acrylate)polymer is a poly(styrene-acrylate)polymer, the shell comprises a soybean oil-based polyurethane and the core comprises the poly(styrene-acrylate)polymer, and the soybean oil-based polyurethane is covalently crosslinked to the poly(styrene-acrylate)polymer.

5. The particle of claim 4 wherein the particle comprises about 10 wt. % to about 95 wt. % of the poly(acrylate)polymer moiety.

6. The particle of claim 5 wherein the poly(acrylate)polymer is a poly(styrene-acrylate)polymer that comprises about 40 wt. % to about 90 wt. % styrene moieties.

7. The particle of claim 6 wherein the vegetable oil-based polyurethane comprises methoxylated soybean oil moieties and urethane moieties derived from polymerized diisocyanate moieties and dimethylol propionic acid (DMPA) moieties.

8. The particle of claim 1 wherein the shell comprises a polymer of Formula I: 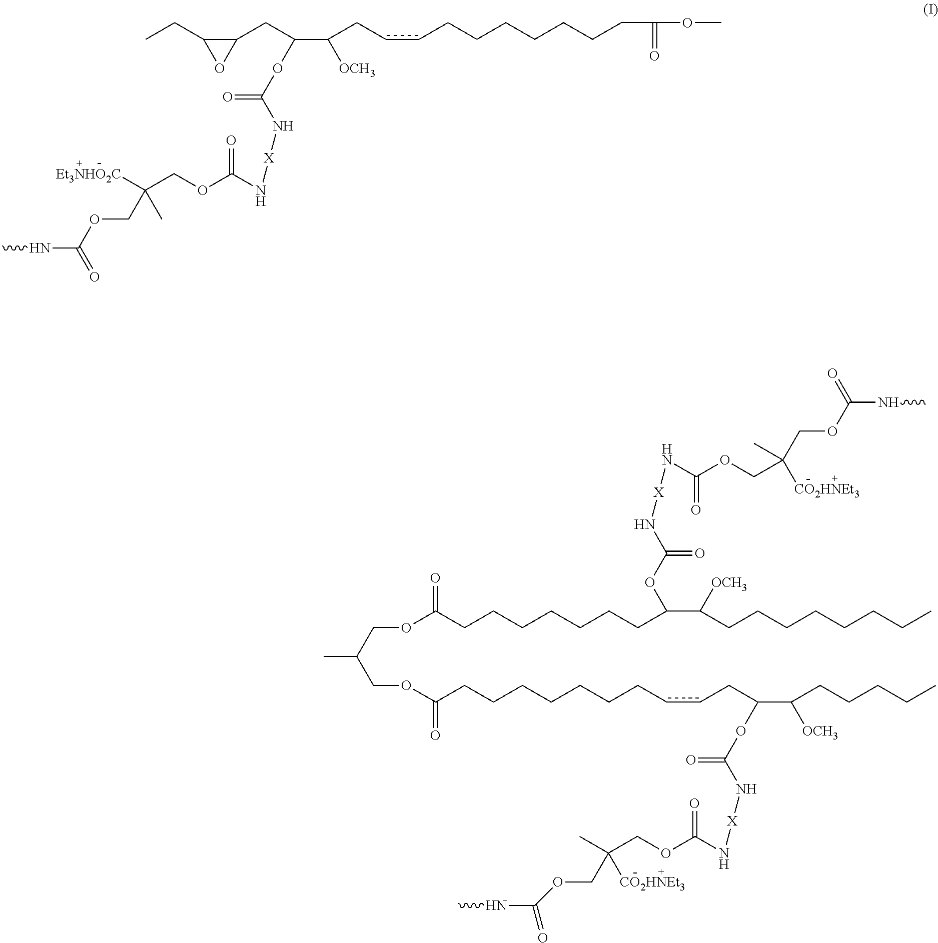
wherein
each X is independently a divalent alkyl, cycloalkyl, or aryl; and
the dashed bonds are double bonds or cites at which the polymer of Formula I is covalently bonded to the poly(acrylate)polymer of the core.

9. The particle of claim 8 wherein the shell comprises a polymer of Formula II: 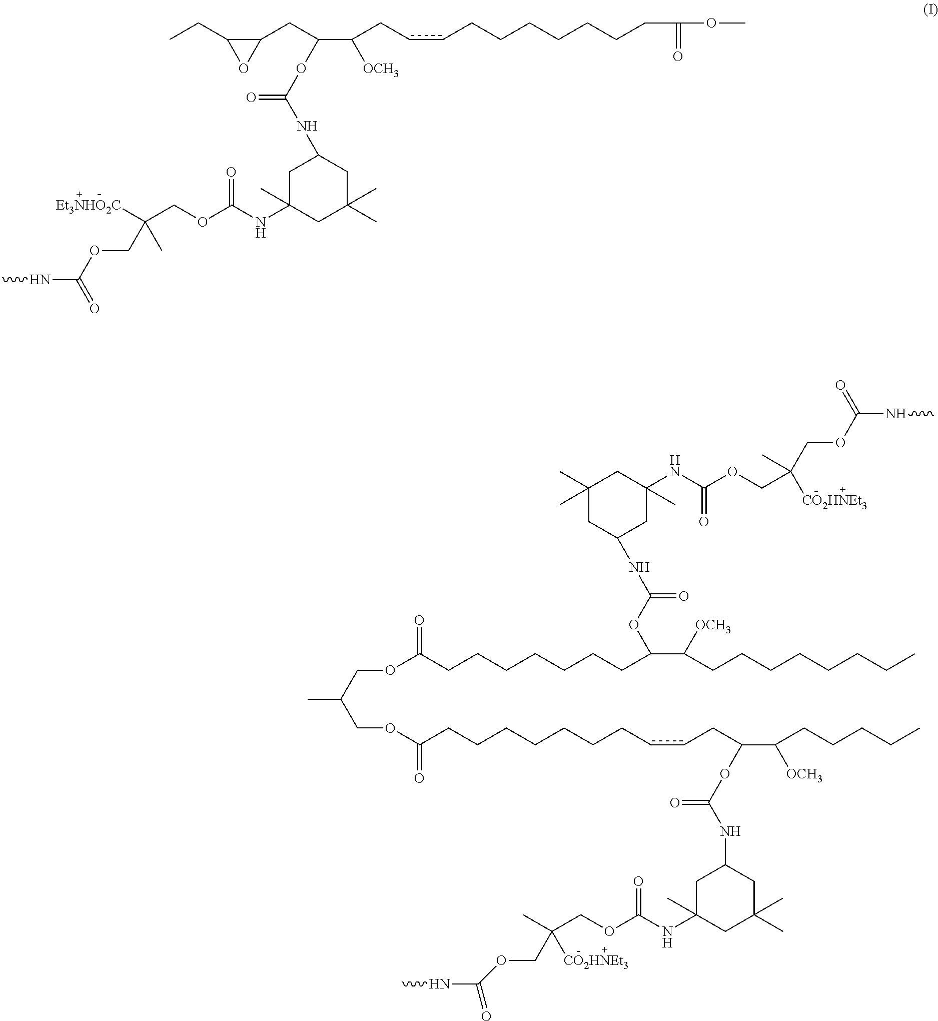
wherein the polymer of Formula II is covalently bonded to the poly(styrene-acrylate)polymer of the core at one or more of the optional olefinic moieties designated by dashed bonds.

10. The particle of claim 1 wherein the vegetable oil-based polyurethane and the poly(acrylate)polymer are crosslinked through divinyl moieties to a poly(styrene-acrylate)polymer.

11. A latex emulsion comprising a plurality of particles of claim 1 and an aqueous solvent system.

12. A latex film comprising a dried layer of a plurality of particles of claim 1, wherein the film possesses a soft segment glass transition temperature and a hard segment glass transition temperature.

13. The film of claim 12 wherein the film has greater thermal stability than a corresponding film that lacks a poly(styrene-acrylate)polymer component, wherein the T₅₀ value is greater than 375° C., as determined by thermal gravimetric analysis, the tensile strength is greater than about 10 MPa, and the Young's modulus is greater than about 200 MPa.

14. A method to prepare a core-shell hybrid latex comprising:
contacting a vegetable-oil based waterborne polyurethane dispersion, one or more acrylates, an effective polymerization initiator, and water;
at a temperature of about 30° C. to about 100° C.;
optionally in the presence of a divinyl crosslinker;
thereby effecting the polymerization of the vegetable-oil based waterborne polyurethane, the acrylates, and optionally the divinyl crosslinker, to form a core-shell hybrid latex in the absence of a surfactant.

15. The method of claim 14 wherein the styrene and the acrylate are present in a ratio of about 40:60 to about 90:10 by weight.

16. The method of claim 15 wherein weight ratio of the polyurethane and the sum of the styrene and the acrylate is about 90:10 to about 40:60.

17. The method of claim 16 wherein about 0.5 wt. % to about 5 wt. % of a divinyl crosslinker is present.

18. The method of claim 17 wherein the soybean oil-based waterborne polyurethane is prepared from methoxylated soybean oil polyols, isophorone diisocyanate (IPDI), and dimethylol propionic acid (DMPA).

19. The method of claim 18 wherein the resulting core-shell hybrid latex is dried to provide a film.

20. The method claim 19 wherein the resulting core-shell hybrid latex is combined with one or more defoamers, substrate wetting agents, rheology control additives, matting agents, coalescing agents, dispersants, adhesives, and water to form a coating, paint, or adhesive formulation.
